(19) United States
(12) Patent Application Publication
(10) Pub. No.: US 2012/0093521 A1
(43) Pub. Date: Apr. 19, 2012

(54) Quantum Repeater And System And Method For Creating Extended Entanglements

(76) Inventors: Keith Harrison, Monmouthshire (GB); William Munro, Bristol (GB); Kae Nemoto, Tokyo (JP)

(21) Appl. No.: 13/378,252

(22) PCT Filed: Oct. 26, 2009
(86) PCT No.: PCT/EP09/64071

§ 371 Date: Dec. 14, 2011

(30) Foreign Application Priority Data
Jun. 30, 2009 (GB) 0911275.6

(51) Int. Cl. H04B 10/16

(52) U.S. Cl. 398/173

(57) ABSTRACT

A method is provided of creating an end-to-end entanglement (89) between qubits in first and second end nodes (81L, 81R) of a chain of optically-coupled nodes whose intermediate nodes (80) are quantum repeaters. Local entanglements (85) are created between qubits in neighbouring pairs in the chain through interaction of the qubits with light fields transmitted between the nodes. A trigger (82) propagated along the chain from one end node (81L), sequentially enables each quantum repeater (100; 210) to effect a top-level cycle of operation. In each such cycle, a repeater (80) initiates a merging of two entanglements involving respective repeater qubits that are at least expected to be entangled with qubits in nodes disposed in opposite directions along the chain from the repeater. A quantum repeater (80) adapted for implementing this method is also provided.

The present invention relates to quantum repeaters and to systems and methods for creating extended entanglements.

### BACKGROUND OF THE INVENTION

In quantum information systems, information is held in the “state” of a quantum system; typically this will be a two-level quantum system providing for a unit of quantum information called a quantum bit or “qubit”. Unlike classical digital states which are discrete, a qubit is not restricted to discrete states but can be in a superposition of two states at any given time.

Any two-level quantum system can be used for a qubit and several physical implementations have been realized including ones based on the polarization states of single photons, electron spin, nuclear spin, and the coherent state of light.

Quantum network connections provide for the communication of quantum information between remote end points. Potential uses of such connections include the networking of quantum computers, and “quantum key distribution” (QKD) in which a quantum channel and an authenticated (but not necessarily secret) classical channel with integrity are used to create shared, secret, random classical bits. Generally, the processes used to convey the quantum information over a quantum network connection provide degraded performance as the transmission distance increases thereby placing an upper limit between end points. Since in general it is not possible to copy a quantum state, the separation of endpoints cannot be increased by employing repeaters in the classical sense.

One way of transferring quantum information between two spaced locations uses the technique known as ‘quantum teleportation’. This makes uses of two entangled qubits, known as a Bell pair, situated at respective ones of the spaced locations; the term “entanglement” is also used in the present specification to refer to two entangled qubits. The creation of such a distributed Bell pair is generally mediated by photons sent over an optical channel (for example, an optical waveguide such as optical fibre). Although this process is distance limited, where a respective qubit from two separate Bell Pairs are co-located, it is possible to combine (or ‘merge’) the Bell pairs by a local quantum operation effected between the co-located qubits. This process, known as ‘entanglement swapping’, results in an entanglement between the two non co-located qubits of the Bell pairs while the co-located qubits cease to be entangled at all.

The device hosting the co-located qubits and which performs the local quantum operation to merge the Bell pairs is called a “quantum repeater”. The basic role of a quantum repeater is to create a respective Bell pair with each of two neighbouring spaced nodes and then to merge the Bell pairs. By chaining multiple quantum repeaters, an end-to-end entanglement can be created between end points separated by any distance thereby permitting the transfer of quantum information between arbitrarily-spaced end points.

It may be noted that while QKD does not directly require entangled states, the creation of long-distance Bell pairs through the use of quantum repeaters facilitates long-distance QKD. Furthermore, most other applications of distributed quantum computation will use distributed Bell pairs.

The present invention is concerned with the creation of entanglement between spaced qubits and with the form, management and interaction of quantum repeaters to facilitate the creation of entanglements between remote end points.

### SUMMARY OF THE INVENTION

According to the present invention, there is provided a quantum repeater as set out in the accompanying claim 1. The quantum repeater is usable as an intermediate node in a chain of nodes, to permit an end-to-end entanglement between qubits in end nodes of the chain of nodes

Also provided is a method of creating an end-to-end entanglement between qubits in end nodes of a chain of nodes whose intermediate nodes are quantum repeaters, the method being as set out in accompanying claim 13.

### BRIEF DESCRIPTION OF THE DRAWINGS

Embodiments of the invention will now be described, by way of non-limiting example, with reference to the accompanying diagrammatic drawings, in which;

FIG. 1A is a diagram depicting a known operation for entangling two qubits;

FIG. 1B is a diagram depicting an elongate operation for extending an existing entanglement to create a new entanglement involving one of the originally-entangled qubits and a new qubit;

FIG. 1C is a diagram depicting a merge operation for extending an existing entanglement by merging it with another entanglement to create a new entanglement involving one qubit from each of the original entanglements;

FIG. 2 is a diagram depicting an entanglement creation subsystem for carrying out an entanglement operation between two qubits located in respective, spaced, nodes;

FIG. 3A is a diagram depicting how a quantum repeater can be used to create an entanglement between two qubits over a distance greater than that possible using the FIG. 1A entanglement operation alone;

FIG. 3B is a diagram illustrating how a chain of quantum repeaters, can be used to create an extended entanglement between any arbitrarily spaced pair of nodes;

FIG. 4 is a diagram illustrating three varieties of a basic quantum physical hardware block, herein a “Q-block”, for carrying out various quantum interactions;

FIG. 5 is a diagram illustrating an implementation of the FIG. 2 entanglement creation subsystem using. Q-blocks;

FIG. 6 is a generic diagram of quantum physical hardware of a quantum repeater;

FIG. 7 is a diagram depicting the general form of quantum repeater embodiments of the invention;

FIG. 8 is a diagram illustrating two successive operating cycles of a process embodying the invention for creating end-to-end entanglements between end nodes of a chain of five optically-coupled nodes, the intermediate nodes of the chain being quantum repeaters of the FIG. 7 form;

FIG. 9 is a diagram of a reliable local-link entanglement creation subsystem for use in quantum repeaters of the FIG. 7 form;

FIG. 10 is a diagram of a first quantum-repeater embodiment, this embodiment basing local-link entanglement creation on subsystems of the FIG. 9 form;

FIG. 11 is a diagram showing how the FIG. 10 quantum repeater cooperates with neighbouring nodes to form two LLE creation subsystems;

FIG. 12 is a diagram showing how FIG. 10 quantum repeaters can be serially optically coupled to provide LLE creation subsystems between neighbouring repeaters;

FIGS. 13A & 13B show respective example implementations of quantum physical hardware of the FIG. 10 quantum repeater embodiment;

FIG. 14 is a state transition diagram of an example state machine implementation of a merge control unit of the FIG. 10 quantum repeater;

FIG. 15 is a diagram illustrating in more detail the first end-to-end operating cycle shown in FIG. 8 for the case of the of the FIG. 8 node chain having quantum repeater nodes of the FIG. 10 form;

FIG. 16 is a diagram of an example implementation of a right end node of a chain of nodes having intermediate nodes formed by FIG. 10 quantum repeaters;

FIG. 17 is a diagram of an example implementation of a left end node of a chain of nodes having intermediate nodes formed by FIG. 10 quantum repeaters;

FIG. 18 is a diagram showing how two complimentary varieties of a repeater based on the FIG. 10 embodiment can be combined to form a repeater chain;

FIG. 19 is a diagram of an alternative local-link entanglement creation subsystem on which quantum repeaters of the FIG. 10 form can be based;

FIG. 20 is a diagram showing an example segmentation of a chain of quantum repeater nodes; and

FIG. 20 is a diagram similar to that of FIG. 15 but for the case of the node chain having quantum repeater nodes based on non-reliable local-link entanglement creation subsystems.

### BEST MODE OF CARRYING OUT THE INVENTION

### Basic Entanglement Creation and Extension Operations

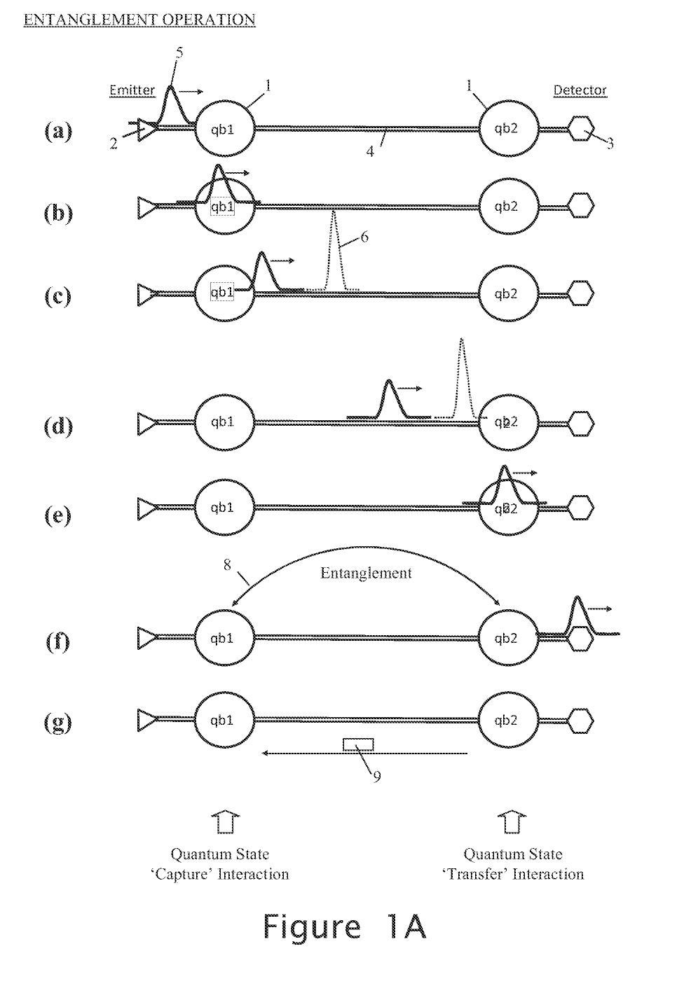

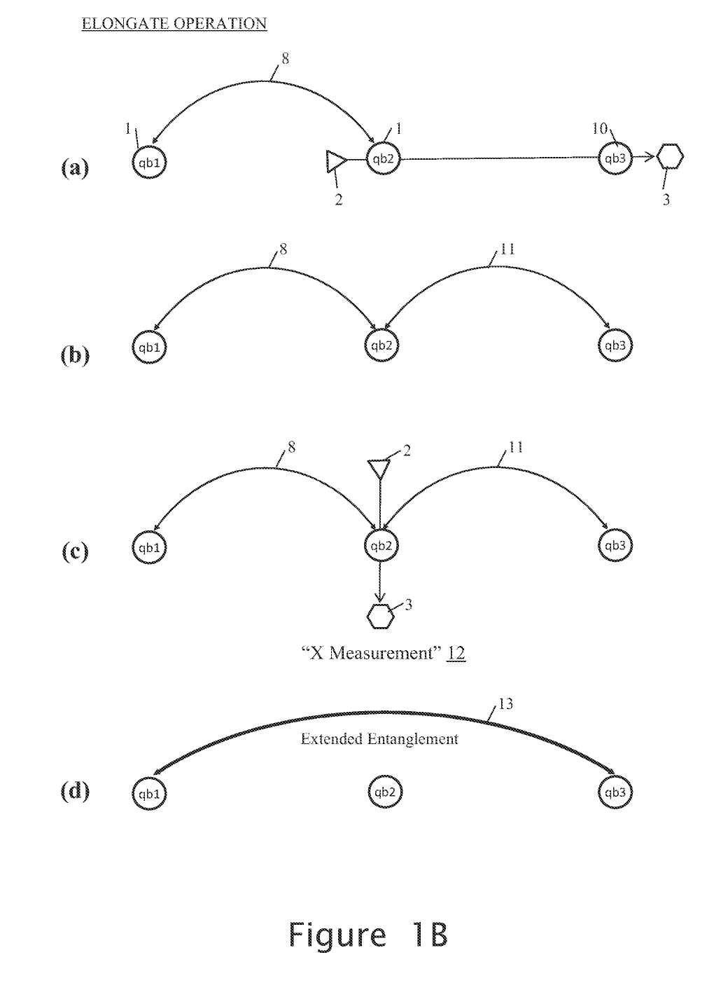

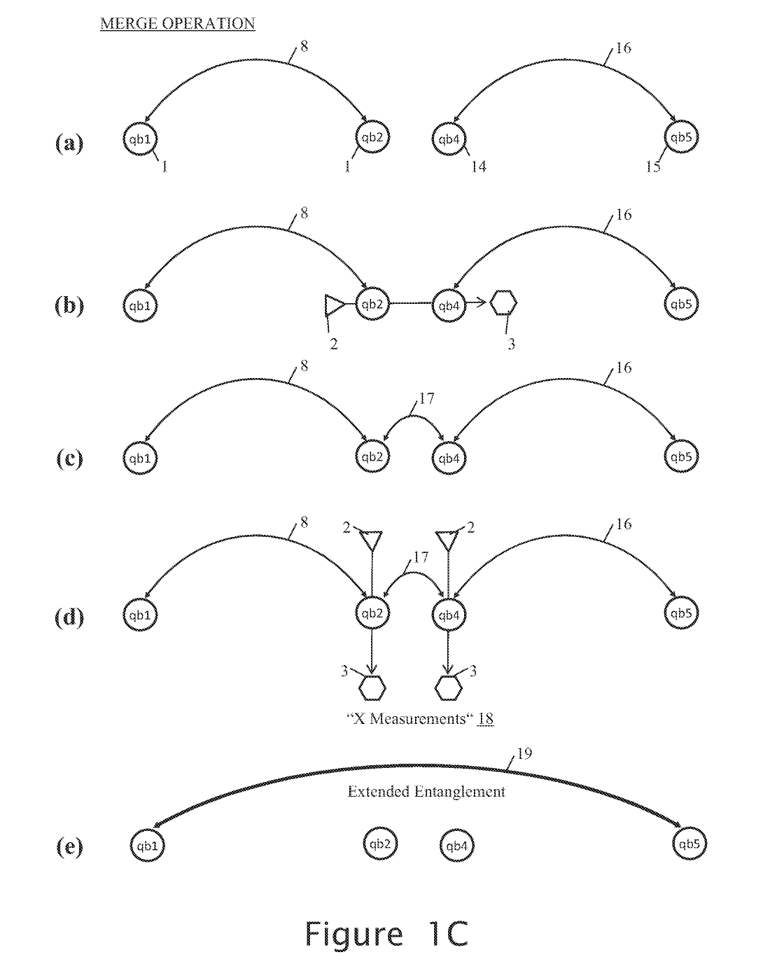

### Entanglement Operation (FIG. 1A)

FIG. 1A depicts, in general terms, a known process (herein referred to as an “entanglement operation”) for entangling two qubits qb1, qb2 (referenced 1) to create a Bell pair, the Figure showing a time series of snapshots (a) to (g) taken over the course of the entanglement operation. Where, as in the present case, the qubits qb1, qb2 are separated by a distance greater than a few millimeters, the creation of a Bell pair is mediated by photons, which may be sent through free space or over a waveguide such as optical fibre 4. Very generally, processes for Bell-pair creation may be divided into those that use very weak amounts of light (single photons, pairs of photons, or laser pulses of very few photons) and those that use pulses of many photons from a coherent source, such as a laser. As will be understood by persons skilled in the art, the details of the methods of creating photons, performing entanglement operations, and making measurements differ depending on whether very weak amounts of light or laser pulses of many photons are used; however, as the present invention can be implemented using any such approach, the following description will be couched simply in terms of a “light field” being used to create (and subsequently extend) Bell Pairs.

Considering FIG. 1A in more detail, a light field 5 emitted by an emitter 2 (snapshot (a)) is passed through the physical qubit qb1 (snapshot (b)) which is in a prepared non-classical state (for example: 0, +1); typically, the physical qubit implementation is as electron spin, the electron being set into a predetermined state immediately prior to passage of the light field. The light field 5 and qubit qb1 interact, with the light field 5 effectively ‘capturing’ the quantum state of the qubit qb1. The light field 5 then travels down the optical fibre 4 (snapshots (c) and (d)) and interacts with qubit qb2 (snapshot (e)) before being measured at detector 3 (snapshot (f); if successful, this results in the ‘transfer’ of the quantum state of qubit qb1 in qubit qb2, entangling these qubits (in FIG. 1A, this entanglement is represented by double-headed arrowed arc 8, this form of representation being used generally throughout the drawings to depict entanglements). The properties of the light field 5 measured by detector 13 enable a determination to be made as whether or not the entanglement operation was successful. The success or failure of the entanglement operation is then passed back to the qb1 end of the fibre 4 in a classical (non-quantum) message 9 (snapshot (g)). This message can be very simple in form (the presence or absence of a single pulse) and as used herein the term “message” is to be understood to encompass both such simple forms as well as structured messages of any degree of complexity (subject to processing time constraints); in embodiments where the message 9 needs to identify a particular qubit amongst several as well as the success or failure of an entanglement operation, the message may still take the form of the presence or absence of a single pulse with the timing of the latter being used to identify the qubit concerned. Where there is a need to transmit information about the success/failure of the entanglement operation (or to identify an involved qubit) back to the qb1 end of the fibre 4, the overall elapsed time thr the entanglement operation is at least the round trip propagation time along the fibre 4, even where the entanglement operation is successful.

An entanglement operation can be performed to entangle qubits qb1 and qb2 whether or not qb2 is already entangled with another cubit (in the case of qb2 already being entangled with another qubit qty when an entanglement operation is performed between qb1 and qb2, this results in the states of all three qubits qb1, qb2 and qbj becoming entangled).

The properties of the light field 5 measured by detector 3 also enable a determination to be made, in the case of a successful entanglement operation, as to whether the entangled states of the qb1 and qb2 are correlated or anti-correlated, this generally being referred to as the ‘parity’ of the entanglement (even and odd parity respectively corresponding to correlated and anti-correlated qubit states). It is normally important to know the parity of an entanglement when subsequently using it; as a result; either parity information must be stored or steps taken to ensure that the parity always ends up the same (for example, if an odd parity is determined, the state of qb2 can be flipped to produce an even parity whereby the parity of the entanglement between qb1 and qb2 always ends up even).

In fact, the relative parity of two entangled qubits is a two dimensional quantity often called the “generalized parity” and comprising both a qubit parity value and a conjugate qubit parity value. For a simple entanglement operation as depicted in FIG. 1A, the conjugate qubit parity value information is effectively even parity and need not be measured. “Generalized parity” requires two classical bits to represent it. In certain applications (such as QKD), knowledge of the conjugate qubit parity value information may not be required. Hereinafter, except where specific reference is being made to one of the components of “generalized parity” (that is, to the qubit parity value or the conjugate qubit parity value), reference to “parity” is to be understood to mean “generalized parity” but with the understanding that in appropriate cases, the conjugate qubit parity value information can be omitted.

As already indicated, the qubits qb1 and qb2 are typically physically implemented as electron spin. However, the practical lifetime of quantum information stored in this way is very short (of the order of 10⁻⁶ seconds cumulative) and therefore generally, immediately laming the interaction of the light field 5 with qb1 and qb2, the quantum state of the qubit concerned is transferred to nuclear spin which has a much longer useful lifetime (typically of the order of a second, cumulatively). The quantum state can be later transferred back to electron spin thr a subsequent light field interaction (such as to perform a merge of two entanglements, described below).

Another practical feature worthy of note is that the physical qubits qb1 and qb2 are generally kept shuttered from light except for the passage of light field 5. To facilitate this at the qb2 end of the fibre 4 (and to trigger setting the qubit into a prepared state immediately prior to its interaction with light field 5), the light field 5 can be preceded by a ‘herald’ light pulse 6; this light pulse is detected at the qb2 end of the fibre 14 and used to trigger priming of the qubit qb2 and then its un-shuttering for interaction with the light field 5. Other ways of triggering these tasks are alternatively possible.

The relationship between the probability of successfully creating a Bell pair, the distance between qubits involved, and the fidelity of the created pair is complex. By way of example, for one particular implementation using a light field in the form of a laser pulse of many photons, Bell pairs are created with fidelities of 0.77 or 0.638 for 10 km and 20 km distances respectively between qubits, and the creation succeeds on thirty eight to forty percent of the attempts. The main point is that the entanglement operation depicted in FIG. 1A is distance limited; for simplicity, in the following a probability of success of 0.25 is assumed at a distance of 10 km.

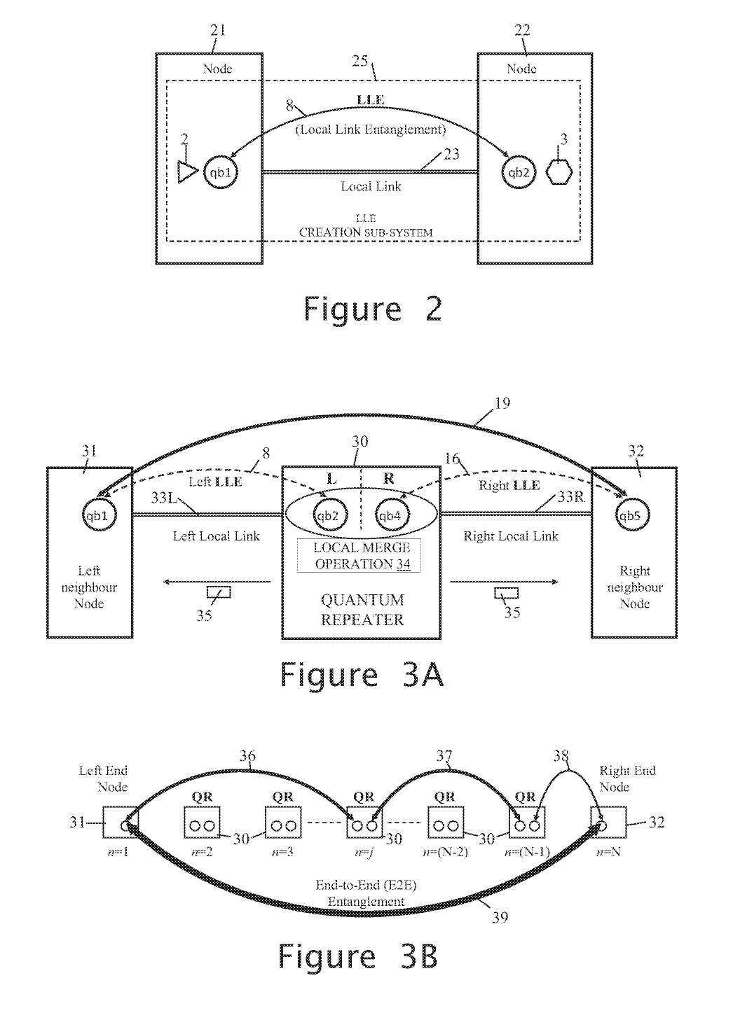

### LLE Creation Subsystem (FIG. 2)

An assembly of components for carrying out an entanglement operation is herein referred to as an “entanglement creation subsystem” and may be implemented locally within a piece of apparatus or between remotely located pieces of apparatus (generally referred to as nodes). FIG. 2 depicts an example of the latter case where two nodes 21 and 22 are optically coupled by an optical fibre 23; optical fibres, such as the fibre 23, providing a node-to-node link are herein called “local link” fibres. The nodes 21, 22 of FIG. 2 include components for implementing respective qubits qb1 and qb2 (for ease of understanding, the same qubit designations are used in FIG. 2 as in FIG. 1A). The qubits qb1 and qb2, together with an emitter 2 associated with qb1, a detector 3 associated with qb3, the local link fibre 23 and entanglement-operation control logic in each node (not shown), form an entanglement creation subsystem 25 for creating an entanglement 8 between qubits qb1 and qb2. An entanglement of this sort created by a light field passed across a local link fibre between nodes is herein called a “local link entanglement” or “LLE”; the node-spanning entanglement creation subsystem 25 is correspondingly called an “LLE creation subsystem”.

### Elongate Operation (FIG. 1B)

An entanglement such as created by a FIG. 1A entanglement operation can be ‘extended’ to create a new entanglement involving one of the originally-entangled qubits and a new qubit, the latter typically being located at a greater distance from the involved originally-entangled qubit than the other originally-entangled qubit. FIGS. 1B and 1C illustrate two ways of extending an initial entanglement 8 between qubits qb1 and qb2 (referenced 1) to form an entanglement between qubit qb1 and another qubit; both ways involve the passing of light fields through various qubits followed by measurement of the light fields but, for simplicity, the light fields themselves and the optical fibres typically used to channel them have been omitted from FIGS. 1B and 1C.

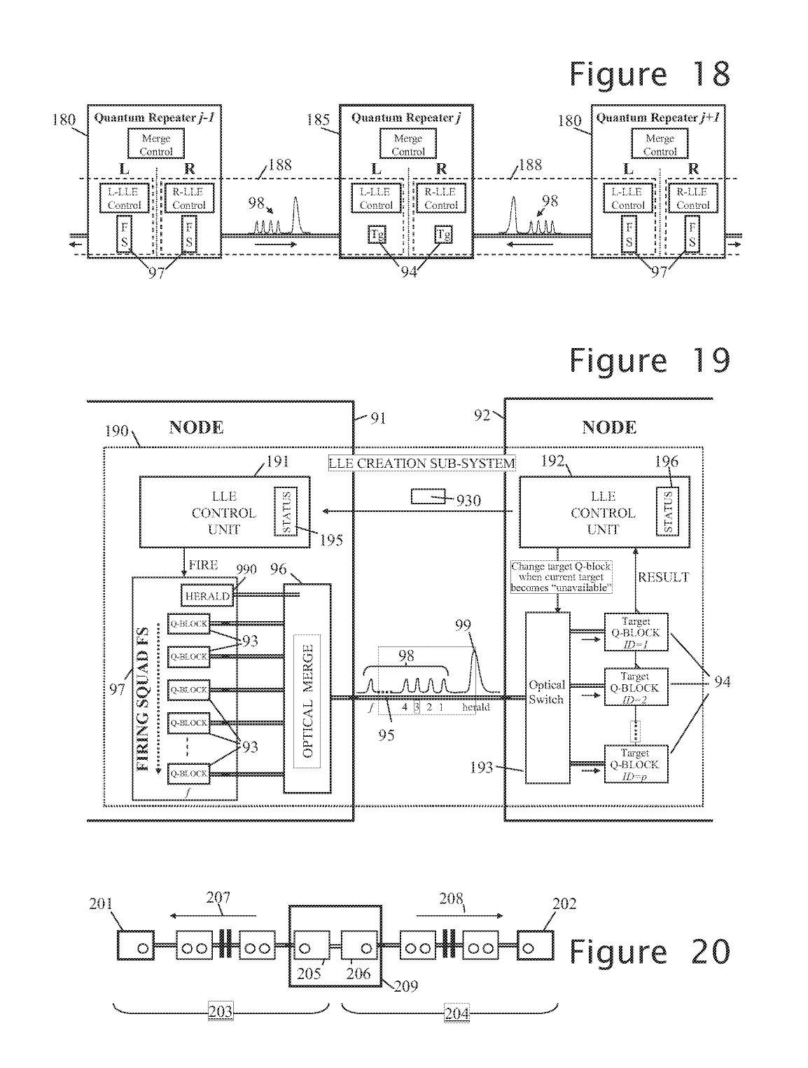

FIG. 18 illustrates, by way of a time series of snapshots (a) to (d), an entanglement extension process that is herein referred to as an “elongate operation”. In general terms, an elongate operation involves further entangling a qubit of an existing first entanglement with a qubit that is not involved in the first entanglement (though it may already be involved, in a different entanglement) to form a linked series of entanglements from which the intermediate qubit (that is, the qubit at the end of the first entanglement being extended) is then removed by measurement to leave an ‘extended’ entanglement between the remaining qubit of the first entanglement and the newly entangled qubit. FIG. 1B illustrates an elongate operation for the simplest case where the qubit that is not involved in the first entanglement is not itself already entangled. More particularly, as shown in snapshot (a) of FIG. 1B, qubit qb2 of an existing entanglement 8 involving qubits qb1 and qb2 (both referenced 1), is further entangled with a qubit qb3 (referenced 10) by means of an entanglement operation. This entanglement operation involves a light field, emitted by an emitter 2, being passed through qubits qb2 and qb3 before being measured by a detector 3. Snapshot (b) depicts the resulting entanglement 11 between qb2 and qb3. The entanglements 8 and 11 form a linked series of entanglements—which is another way of saying that the states of qb1, qb2 and qb3 are now entangled with each other. A particular type of measurement, herein an “X measurement” (referenced 12 in FIG. 1B), is then effected on the intermediate qubit qb2 by sending a light field from an emitter 2 through qb2 and detecting it with a detector 3, thereby to eliminate qb2 from entanglement with qb1 and qb3 (see snapshot (c)) leaving qb1 and qb3 entangled. A characteristic of the X measurement 12 is that it is done in a manner so as to give no information about the rest of the quantum state of entangled qubits qb1 and qb3; for example, for a joint state between qubits qb1, qb2 and qb3 like “a|000>+b|111>” where a and b are probability amplitudes, an X measurement on qubit qb2 would give a state for the entanglement between qb1 and qb3 of either “a|00>+b|11>” (for an X measurement result of +1) or “a|00>−b|11>” (for an X measurement result of −1). This measurement does not give any information about a or b.

After the X measurement 12 has been made to eliminate qb2 from entanglement, an extended entanglement is left between qb1 and qb3—this extended entanglement is depicted as medium thick arc 13 in snapshot (d) of FIG. 1B.

The parity of the extended entanglement 13 is a combination of the parities of the entanglements 8 and 11 and a conjugate qubit parity value determined from the X measurement (in the above example, the X measurement gives either a +1 or −1 result—this sign is the conjugate qubit parity value). Where qubit parity value information and conjugate qubit parity value information are each represented by binary values ‘0’ and ‘1’ for even and odd parity respectively, the qubit parity value information and conjugate qubit parity value information of the extended entanglement are respective XOR (Exclusive OR) combinations of the corresponding component parities.

It may be noted that a functionally equivalent result to the FIG. 1B elongate operation can be obtained by first entangling qb3 with qb2 by means of an entanglement operation in which the mediating light field passes first through qb3, and then removing qb2 from entanglement by effecting an X measurement on it. In the present specification, for linguistic clarity, reference to an ‘elongate operation’ (with its integral X measurement) only encompasses the case where the initial entanglement performed as part of the elongate operation is effected by a light field first passing through a qubit of the entanglement being extended; the above described functional equivalent to the elongate operation is treated as being separate entanglement and X measurement operations.

Where the objective is to set up an entanglement between two qubits spaced by a substantial distance, the elongate operation described above with reference to FIG. 1B is not that useful by itself. This is because should the component entanglement operation (see (a) of FIG. 1B) fail, then the pre-existing entanglement that is being extended (entanglement 8 in FIG. 1B) will be destroyed. In effect, the probability of successfully creating the extended entanglement 13 is the product of the success probabilities of the entanglement operations used to create entanglements 8 and 11. As already noted, the probability of a successful entanglement operation is distance related so the chances of successfully creating an entanglement over long distances using only elongate operations to successively extend an initial entanglement, are poor. The same problem exists with the described functional equivalent of the elongate operation.

### Merge Operation (FIG. 1C)

A better approach is to use the merge operation illustrated in FIG. 1C to knit together independently created entanglements that individually span substantial distances; this approach effectively decouples the success probabilities associated with the individual entanglements as a failure of one attempt to create such an entanglement does not destroy the other entanglements. Of course, to be useful, the merge operation used to join the individual entanglements must itself be highly reliable and this is achieved by carrying it out over extremely short distances.

FIG. 1C illustrates, by way of a time series of snapshots (a) to (e), an example embodiment of a merge operation for ‘extending’ an entanglement 8 existing between qubits qb1 and qb2 by merging it with another entanglement 16 that exists between qubits qb4 (referenced 14) and qb5 (referenced 15), in order to end up with an ‘extended entanglement’ between qb1 and qb5 (medium thick arc 19 in FIG. 1C). The qubits qb2 and qb4 are located in close proximity to each other (typically within tens of millimeters). The order in which the entanglements 8 and 16 are created is not relevant (indeed they could be created simultaneously); all that is required is that both entanglements exist in a usable condition at a common point in time. At such a time, the entanglements 8 and 16 are “merged” by a quantum operation carried out locally on qubits qb2 and qb4. (Where the quantum states of cubits qb2, qb4 have been transferred from electron spin to nuclear spin immediately following the creation of the LLEs 8, 16 respectively, these states need to be transferred back to electron spin before the merge operation is effected). The local merge operation involves a first process akin to that of FIG. 1A entanglement operation effected by passing a light field, emitted by an emitter 2, successively through the two qubits qb2 and qb4, or vice versa, and then measuring the light field (see snapshot (b) of FIG. 1C). This first process, if successful, results in the qubits qb2 and qb4 becoming entangled (as indicated by entanglement 17 in snapshot (c) of FIG. 1C) creating a linked series of entanglements by which qubits qb1 and qb5 are entangled with each other. A second measurement process comprising one or more X measurements 18 (see snapshot (d) of FIG. 1C) is then used to remove the intermediate qubits qb2 and qb4 from the entangled whole leaving an ‘extended’ entanglement 19 between the qubits qb1 and qb5 The qubits qb2 and qb4 finish up neither entangled with each other nor with the qubits qb1, qb5. Because the merge operation is a local operation between two co-located qubits, the probability of success is very high.

The measurements made as part of the merge operation provide both an indication of the success or otherwise of the merge, and an indication of the “generalized parity” of the merge operation. For example, the first merge-operation process may measure a qubit parity value and the second merge-operation process, the conjugate qubit parity value. In this case, the second process can be effected either as a single X measurement using a light field passed through both qubits qb2 and qb4 (in which ease the light field has a different value to that used in the first process e.g. 0,+1 as opposed to 0,−1), or as individual X measurements, subsequently combined, made individually on qb2, and qb4, the latter approach being depicted in FIG. 1C. The parity of the extended entanglement 19 will be a combination of the parities of the entanglements 8 and 15 and the parity of the merge operation. As before, where qubit parity value information and conjugate qubit parity value information are each represented by binary values ‘0’ and ‘1’ for even and odd parity respectively, the qubit parity value information and conjugate qubit parity value information of the extended entanglement are respective XOR (Exclusive OR) combinations of the corresponding component parities.

Information about the success or otherwise of the merge operation is passed in classical messages to the end qubit locations as otherwise these locations do not know whether the qubits qb1, qb5 are entangled; alternatively since the failure probability of a merge operation is normally very low, success can be assumed and no success/failure message sent—in this case, it will be up to applications consuming the extended entanglement 19 to detect and compensate for merge failure leading to absence of entanglement. As the parity of the extended entanglement will normally need to be known to make use of the entangled qubits, parity information needed to determine the parity of the extended entanglement 19 is also passed on to one or other of the end qubit locations.

It will be appreciated that the form of merge operation described above with respect to FIG. 1C is effectively an elongate operation carried out over a very short distance between qb2 and qb4 to extend entanglement 8, together with an X measurement on qb4 to remove it from entanglement (qb2 having been removed from entanglement by the X measurement performed as part of the elongate operation). Of course, unlike the FIG. 1B example elongate operation where the qubit qb3 to which the entanglement 8 is being extended is not itself already entangled, the equivalent qubit qb4 FIG. 1C is already involved in a second entanglement 16; however, as already noted, an elongate operation encompasses this possibility.

As already noted, the merge operation is a local operation (between qubits qb2 and qb3 in FIG. 1C) that is effected over a very short distance and thus has a high probability of success. A merge operation takes of the order of 10⁻⁹ secs.

### Quantum Repeater (FIGS. 3A & 3B)

In practice, when seeking to create an extended entanglement between two qubits which are located in respective end nodes separated by a distance greater than that over which a basic entanglement operation can be employed with any reasonable probability of success, one or more intermediate nodes, called quantum repeaters, are used to merge basic entanglements that together span the distance between the end nodes. Each quantum repeater node effectively implements a merge operation on a local pair of cubits that correspond to the qubits qb2 and qb4 of FIG. 1C and are involved in respective entanglements with qubits in other nodes. FIG. 3A depicts such a quantum repeater node 30 forming one node in a chain (sequential series) of nodes terminated by left and right end nodes 31 and 32 that respectively accommodate the qubits qb1, qb5 it is desired to entangle (but which are too far apart to entangle directly using an entanglement operation). In the present example, the chain of nodes comprises three nodes with the left and right end nodes 31, 32 also forming the left and right neighbour nodes of the quantum repeater 30. The quantum repeater 30 is connected to its left and right neighbour nodes 31, 32 by left and right local link optical fibres 33L and 33R respectively. It is to be noted that the terms “left” and “right” as used throughout the present specification are simply to be understood as convenient labels for distinguishing opposite senses (directions along; ends of; and the like) of the chain of nodes that includes a quantum repeater.

The quantum repeater 30 effectively comprises left and right portions or sides (labeled “L” and “R” in FIG. 3A) each comprising a respective qubit qb2, qb4 (for ease of understanding, the same qubit designation are used in FIG. 3A as in FIG. 1C). The qubit qb1 of the left neighbour node 31 and qb2 of the quantum repeater node 30 are part of a LLE creation subsystem formed between these nodes and operative to create a left LLE 8 (shown as a dashed arrowed arc 8 in FIG. 3A) between qb1 and qb2. Similarly, the qubit qb5 of the right neighbour node 32 and qb4 of the quantum repeater node 30 are part of a LLE creation subsystem formed between these nodes and operative to create a right LLE 16 between qb5 and q4.

It may be noted that the direction of travel (left-to-right or right-to-left) of the light field used to set up each LLE is not critical whereby the disposition of the associated emitters and detectors can be set as desired. For example, the light fields involved in creating LLEs 8 and 16 could both be sent out from the quantum repeater 30 meaning that the emitters are disposed in the quantum repeater 30 and the detectors in the left and right neighbour nodes 31, 32. However, to facilitate chaining of quantum repeaters of the same form, it is convenient if the light fields all travel in the same direction along the chain of nodes; for example, the light fields can be arranged all to travel from left to right in which case the left side L of the quantum repeater 30 will include the detector for creating the left LLE 8 and the right side R will include the emitter for creating the right LLE 16. For simplicity, and unless otherwise stated, a left-to-right direction of travel of the light field between the nodes will be assumed hereinafter unless otherwise stated; the accompanying Claims are not, however, to be interpreted as restricted to any particular direction of travel of the light field, or to the direction of travel being the same across different links, unless so stated or implicitly required.

In operation of the quantum repeater 30, after creation, in any order, of the left and right LLEs 8 and 16, a local merge operation 34 involving the cubits qb2 and qb4 is effected thereby to merge the left LLE 8 and the right LLE 16 and form extended entanglement 19 between the qubits qb1 and qb5 in the end nodes 31 and 32 respectively.

If required, information about the success or otherwise of the merge operation and about parity is passed in classical messages 35 from the quantum repeater 30 to the nodes 31, 32.

Regarding the parity information, where the parity of the local link entanglements has been standardized (by qubit state flipping as required), only the merge parity information needs to be passed on by the quantum repeater and either node 31 or 32 can make use of this information. However, where LLE parity information has simply been stored, then the quantum repeater needs to pass on whatever parity information it possesses; for example, where the parities of the left and right LLEs 8, 16 are respectively known by the quantum repeater 30 and the node 32, the quantum repeater 30 needs to pass on to node 32 both the parity information on LLE 8 and the merge parity information, typically after combining the two. Node 32 can now determine the parity of the extended entanglement by combining the parity information it receives from the quantum repeater 30 with the parity information it already knows about LLE 16.

From the foregoing, it can be seen that although the merge operation itself is very rapid (of the order of 10⁻⁹ seconds), there is generally a delay corresponding to the message propagation time to the furthest one of the nodes 31, 32 before the extended entanglement 19 is usefully available to these nodes.

By chaining together multiple quantum repeaters, it is possible to create an extended entanglement between any arbitrarily spaced pair of nodes. FIG. 3B illustrates this for a chain of N nodes comprising left and right end nodes 31 and 32 respectively, and a series of (N−2) quantum repeaters 30 (each labeled “QR” and diagrammatically depicted for simplicity as a rectangle with two circles that represent L and R qubits). The nodes 30-32 are interconnected into a chain by optical fibres (not shown) and are numbered from left to right—the number n of each node is given beneath each node and node number “j” represents an arbitrary QR node 30 along the chain. The node number of a QR node can be used as a suffix to identify the node; thus “QRⱼ” is a reference to the quantum repeater node numbered j. This node representation, numbering and identification is used generally throughout the present specification.

In FIG. 3B, three existing entanglements 36, 37, and 38 are shown between qubits in respective node pairings; for convenience, when referring at a high level to entanglements along a chain of nodes, a particular entanglement will herein be identified by reference to the pair of nodes holding the qubits between which the entanglement exists, this reference taking the form of a two-element node-number tuple. Thus, entanglement 38, which is a local link entanglement LLE between qubits in the neighbouring nodes numbered (N−1) and N, is identifiable by the node number tuple {(N−1), N}. Entanglements 36 and 37 (shown by medium thick arcs in FIG. 3B) are extended entanglements existing between qubits in the node pairings {1,j} and {j,(N−1)} respectively, these entanglements having been created by the merging of LLEs. To create an end-to-end (abbreviated herein to “E2E”) entanglement between qubits in the left and right end nodes 31, 32 (see thick arc 39 in FIG. 3), entanglements 36 and 37 can first be merged by QRⱼ with the resultant extended entanglement then being merged with LLE 38 by QR_{(N-1)}; alternatively, entanglements 37 and 38 can first be merged by QR_{(N-1)} with the resultant extended entanglement then being merged with entanglement 36 by QRⱼ.

### Entanglement Build Path

The “entanglement build path” (EBP) of an entanglement is the aggregate qubit-to-qubit path taken by the mediating light field or fields used in the creation of an un-extended or extended entanglement; where there are multiple path segments (that is, the path involves more than two qubits), the light fields do not necessarily traverse their respective segments in sequence as will be apparent from a consideration of how the FIG. 3B E2E entanglement is built (in this example, the entanglement build path is the path from one end node to the other via the left and right side qubits the chain of quantum repeaters),

### Representation of Low Level Quantum Physical Hardware

The particular form of physical implementation of a qubit and the details of the methods of performing entanglement, elongate, and merge operations (for example, whether very weak amounts of light or laser pulses of many photons are used) are not of direct relevance to the present invention and accordingly will not be further described herein, it being understood that appropriate implementations will be known to persons skilled in the art. Instead, the physical hardware for implementing the quantum operations (the “quantum physical hardware”) will be represented in terms of a basic block, herein called a “Q-block”, that provides for the implementation of and interaction with, one qubit, and an associated optical fabric.

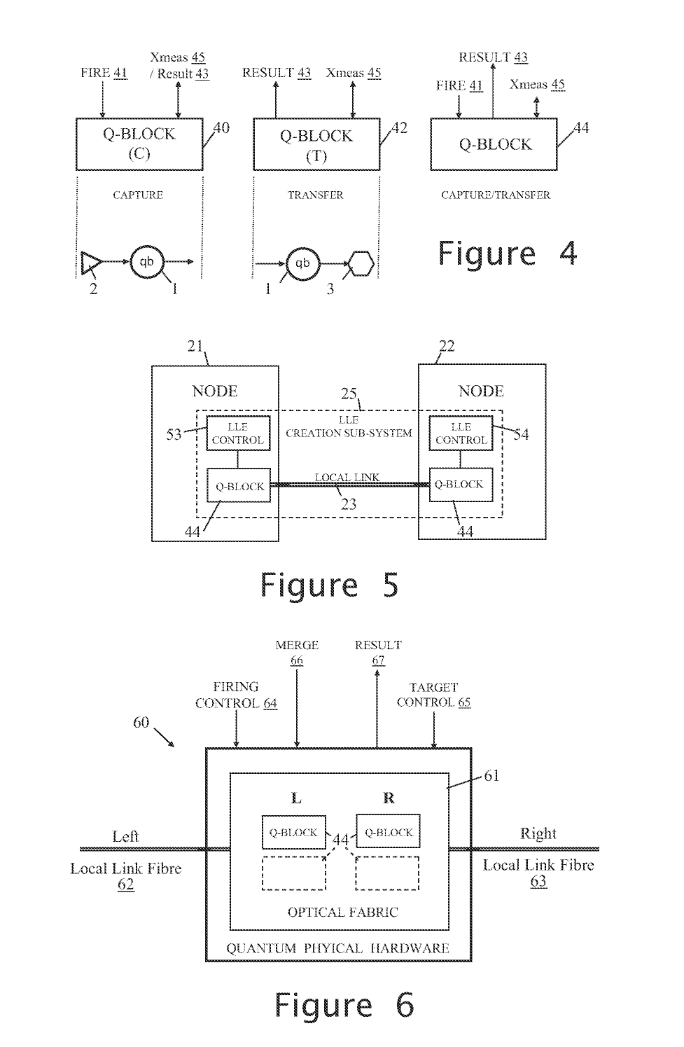

FIG. 4 depicts three varieties of Q-block, respectively referenced 40, 42 and 44.

Q-block variety 40 represents the physical hardware needed to manifest a qubit and carry out the “Capture” interaction of FIG. 1A with that qubit, that is, the controlled sending of a light field through the qubit in a prepared state. This variety of Q-block—herein called “a Capture Q-block” (abbreviated in the drawings to “Q-block (C)”)—comprises a physical implementation of a qubit 10 and a light-field emitter 12, together with appropriate optical plumbing, functionality for putting the qubit in a prepared state and for shuttering it (for example, using an electro-optical shutter) except when a light field is to be admitted, functionality (where appropriate for the qubit implementation concerned) for transferring the qubit state between electron spin and nuclear spin (and vice versa) as needed, and control functionality for coordinating the operation of the Capture Q-block to send a light field through its qubit (and on out of the Q-block) upon receipt of a “Fire” signal 41.

Q-block variety 42 represents the physical hardware needed to manifest a qubit and carry out the “Transfer” interaction of FIG. 1A with that qubit, that is, the passing of a received light field through the qubit in a prepared state followed by measurement of the light field. This variety of Q-block—herein called “a Transfer Q-block” (abbreviated in the drawings to “Q-block (T)”)—comprises a physical implementation of a qubit 10 and a light-field detector 13, together with appropriate optical plumbing, functionality (responsive, for example to a herald light pulse 6) for putting the qubit in a prepared state and for shuttering it except when a light field is to be admitted, functionality (where appropriate for the qubit implementation concerned) for transferring the qubit state between electron spin and nuclear spin (and vice versa) as needed, and control functionality for coordinating the operation of the Transfer Q-block and for outputting the measurement results 43.

Q-block variety 44 is a universal form of Q-block that incorporates the functionality of both of the Capture and Transfer Q-block varieties 40 and 42 and so can be used to effect both Capture and Transfer interactions. For convenience, this Q-Block variety is referred to herein simply as a “Q-block” without any qualifying letter and unless some specific point is being made about the use of a Capture or Transfer Q-block 40, 42, this is the variety of Q-block that will be generally be referred to even though it may not in fact be necessary for the Q-block to include both Capture and Transfer interaction functionality in the context concerned—persons skilled in the art will have no difficulty in recognizing such cases and in discerning whether Capture or Transfer interaction functionality is required by the Q-block in its context. One reason not to be more specific about whether a Q-block is of a Capture or Transfer variety is that often either variety could be used provided that a cooperating Q-block is of the other variety (the direction of travel of light fields between them not being critical).

Regardless of variety, every Q-block will be taken to include functionality for carrying out an X measurement in response to receipt of an Xmeas signal 45 thereby enabling the Q-block to be used in elongate and merge operations; the X measurement result is provided in the Result signal 43, it being appreciated that where the Q-block has Transfer interaction functionality, the X measurement functionality will typically use the detector 2 associated with the Transfer interaction functionality. X measurement functionality is not, of course, needed for an entanglement operation and could therefore be omitted from Q-blocks used only for such operations.

It may be noted that where there are multiple Q-blocks in a node, the opportunity exists to share certain components between Q-blocks (for example, where there are multiple Q-blocks with Capture interaction functionality, a common light-field emitter may be used for all such Q-blocks). Persons skilled in the art will appreciate when such component sharing is possible.

An entanglement operation will involve a Q-block with Capture interaction functionality (either a Transfer Q-block 40 or a universal Q-block 44) optically coupled to a Q-block with Transfer interaction functionality (either a Transfer Q-block 42 or a universal Q-block 44), the entanglement operation being initiated by a Fire signal 41 sent to the Q-block with Capture interaction functionality and the success/failure of the operation being indicated in the result signal 43 output by the Q-block with Transfer interaction functionality.

Where an elongate operation is to be effected, the initial entanglement-operation component of the elongate operation will also involve a Q-block with Capture interaction functionality and a Q-block with Transfer interaction functionality. The provision of X measurement functionality in all varieties of Q-block enables the subsequent removal from entanglement of the intermediate qubit to be effected by sending an Xmeas signal to the Q-block implementing this guild, the measurement results being provided in the result signals 43 output by this Q-block.

Where a merge operation is to be effected, this will also involve a Q-block with Capture interaction functionality and a Q-block with Transfer interaction functionality. Again, the provision of X measurement functionality in all varieties of Q-block enables the removal from entanglement of the qubit(s) involved in the merge operation. Measurement results are provided in the result signals 43 output by the appropriate Q-blocks.

FIG. 5 depicts the FIG. 2 LLE creation subsystem 25 as implemented using respective Q-blocks 44. A respective Q-block 44 is provided in each node 21 and 22, these Q-blocks 44 being optically coupled through the local link fibre 23. Each Q-block 44 has associated control logic formed by LLE control unit 53 in node 21 and LLE control unit 54 in node 54, 53, Because the Q-blocks 44 depicted in FIG. 5 are of the universal variety, the direction of travel along the local link fibre 23 of light fields involved, in entanglement creation is not tied down; thus, the Q-block 44 of the node 21 could serve as a Capture Q-block and that of node 22 as a Transfer Q-block or the Q-block 44 of the node 21 could serve as a Transfer Q-block and that of node 51 as a Capture Q-block.

In the LLE creation subsystem 25 of FIG. 5, the single Q-blocks 44 are simply coupled directly to the local link fibre 23. However, in many cases there will be a need to provide a controllable optical fabric in a node to appropriately guide light fields to/from the Q-block(s) of the node depending on its current operational requirements. For example, where there are multiple Q-blocks in a node sharing the same external fibre, an optical fabric may be required to merge outgoing light fields onto the common fibre or direct incoming light fields from the fibre to selected. Q-blocks; in another example, an optical fabric may be required in a quantum repeater node (such as node 30 in FIG. 3A) to switch a L-side Q-block and a R-side Q-block from optically interfacing with respective left and right local link fibres for LLE creation, to optically interfacing with each other for a local merge operation.

In general terms, therefore, the quantum physical hardware of a node, that is, the physical elements that implement and support qubits and their interaction through light fields, comprises not only one or more Q-blocks but also an optical fabric in which the Q-block(s) are effectively embedded. By way of example, FIG. 6 depicts such a representation for a quantum repeater node; thus, quantum physical hardware 60 is shown as comprising an optical fabric 61 for guiding light fields to/from the Q-blocks 44 and the Q-blocks 44 are depicted as existing within the optical fabric 61 with the local link fibres 62, 63 coupling directly to the optical fabric. One L-side and one R-side Q-block are shown in solid outline and possible further L-side and R-side Q-blocks are indicated by respective dashed-outline Q-blocks.

As employed herein, any instance of the above-described generalized quantum physical hardware representation (such as the instance shown in FIG. 6 in respect of a quantum repeater), is intended to embrace all possible implementations of the quantum physical hardware concerned, appropriate for the number and varieties of Q-blocks involved and their intended roles. (It may be noted that although FIG. 6 shows the Q-blocks as Q-blocks 44—that is, of the Universal variety—this is simply to embrace all possible implementations and is not a requirement of the role being played by the Q-blocks in the quantum repeater; a particular implementation may use other varieties of Q-blocks as appropriate to their roles. This use of Q-blocks 44 in the above-described generalized quantum physical hardware representation is not limited to the FIG. 6 representation of quantum physical hardware for a quantum repeater).

Depending on the quantum operations to be performed by the quantum physical hardware, the latter is arranged to receive various control signals and to output result signals, In the case of the FIG. 6 quantum physical hardware block 60 appropriate for a quantum repeater, the quantum physical hardware is arranged to receive “Firing Control” and “Target Control” signals 64, 65 for controlling entanglement creation operations, to receive “Merge” signals 67 for controlling merge operations, and to output “Result” signals 66 indicative of the outcome of these operations. The signals 64-67 may be parameterized to indicate particular Q-blocks. Target Control signals are not needed in some quantum repeater embodiments as will become apparent hereinafter. In one implementation of the FIG. 6 quantum physical hardware 60, the Firing Control signals 64 comprise both:
set-up signals for appropriately configuring the optical fabric 61 (if not already so configured) to optically couple one or more Q-block(s) with Capture interaction functionality to one of the local link fibres, and
the previously-mentioned “Fire” signal(s) thr triggering light-field generation by one or more of the Q-block(s) with Capture interaction functionality;
   and the Target Control signals 65 comprise:
set-up signals for appropriately configuring the optical fabric 61 (if not already so configured) to optically couple a Q-block with Transfer interaction functionality to one of the local link fibres.

Furthermore, in this implementation, the Merge signals 66 comprise both:
set-up signals for appropriately configuring the optical fabric 61 (if not already so configured) to effect a merge operation involving a L-side and R-side Q-block of the repeater,
a “Fire” signal for triggering the first merge-operation process, and
Where the FIG. 1C form of merge operation is being carried out, one or more Xmeas signals to instigate the X measurements that form the second merge-operation process.

For quantum physical hardware intended to perform elongate operations, the quantum physical hardware, as well as being arranged to receive Firing Control signals (for performing the entanglement creation component of the elongate operation) and to output Result signals, is also arranged to receive Xmeas signals for instigating X measurements whereby to complete the elongate operation.

The optical fabric of a node may have a default configuration. For example, where the FIG. 6 quantum physical hardware 60 only includes one L-side and one R-side Q-block, the optical fabric 61 may be arranged to default to an LLE creation configuration optically coupling the Q-blocks to respective ones of the local link fibres. In this case, the merge signals 66 are arranged to only temporarily optically couple the two Q-blocks to each other for the time needed to carry out a merge operation. In cases such as this, the Target Control signals 65 can be dispensed with entirely and the Firing Control signals 64 simply comprise Fire signals sent to the appropriate Q-block.

### General Form of Quantum Repeater Embodiments

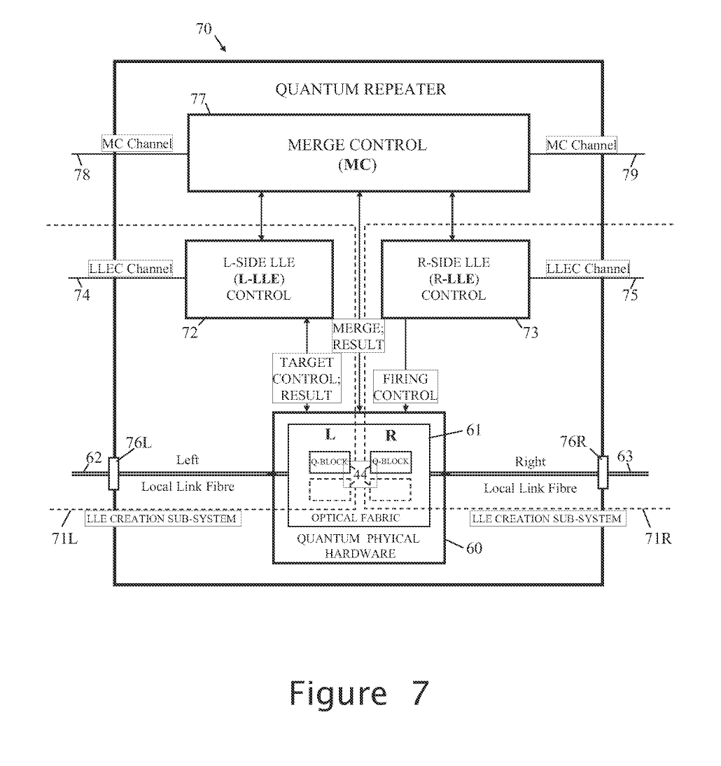

FIG. 7 depicts the general form of the quantum repeater embodiments to be described hereinafter.

More particularly, quantum repeater 70 comprises quantum physical hardware 60 of the form described above with respect to FIG. 6 and including one or more L-side and R-side Q-blocks 44, and optical fabric 61 coupled to left and right local link fibres 62, 63 via respective optical interfaces 76L, 76R. As already indicated, for convenience and without limitation, the light fields involved in LLE creation will be taken (unless otherwise stated) as travelling from left to right along the local link fibres between nodes, whereby the R-side Q-block(s) of the FIG. 7 repeater 70 act as Capture Q-block(s) during LLE creation (forming a right-side LLE creation subsystem 71R with L-side Q-block(s) in a right neighbour node, not shown), and the L-side Q-block(s) of the repeater 70 act as Transfer Q-block(s) during LLE creation (forming a left-side LLE creation subsystem 71R with R-side Q-block(s) in a left neighbour node, not shown).

An R-side LLE (“R-LLE”) control unit 73 is responsible for generating the Firing Control signals that select (where appropriate) and trigger firing of the R-side Q-block(s) in respect of LLE creation. An L-side LLE (“L-LLE”) control unit 72 is responsible thr generating, where appropriate, the Target Control signals for selecting the L-side Q-block(s) to participate in LLE creation; the L-LLE control unit 72 is also arranged to receive the Result signals from the quantum physical hardware 60 indicative of the success/failure of the LLE creation operations involving the L-side Q-blocks.

It will thus be appreciated that initiation of right-side LLE creation is effectively under the control of the R-LLE control unit 73 of the repeater 70 (as unit 73 is responsible for generating the Fire signal for the R-side Q-block involved in creating the right-side LLE); initiation of left-side LLE creation is, however, effectively under the control of the R-LLE control unit in the left neighbour node.

LLE control (“LLEC”) classical communication channel 74 inter-communicates the L-LLE control unit 72 with the R-LLEC unit of the left neighbour node (that is, the R-LLE control unit associated with the same LLE creation subsystem 71L as the L-LLE control unit 72); the L-LLEC unit 72 uses the LLEC channel 74 to pass LLE creation success/failure messages (message 15 in FIG. 1) to the R-LLE control unit of the left neighbour node.

An LLE control (“LLEC”) classical communication channel 75 inter-communicates the R-LLE control unit 73 with the L-LLE control unit of the right neighbour node (that is, the L-LLE control unit associated with the same LLE creation subsystem 71R as the R-LLE control unit 73); the R-LLE control unit 73 receives LLE creation success/failure messages (message 15 in FIG. 1) over the LLEC channel 75 from the L-LLE control unit of the right neighbour node.

Messages on the LLEC channels 74, 75 are referred to herein as ‘LLEC’ messages.

It will be appreciated that where the light fields involved in LLE creation are arranged to travel from right to left along the local link fibres between nodes (rather than from left to right), the roles of the L-side and R-side LLE control units 72, 73 are reversed.

A merge control (“MC”) unit 77 is responsible for generating the Merge signals that select, where appropriate, local Q-blocks to be merged, and trigger their merging The MC unit 77 is also arranged to receive from the quantum physical hardware 60, the Result signals indicative of the success/failure and parity of a merge operation.

A merge control (“MC”) classical communication channel 78, 79 inter-communicates the MC unit 77 with corresponding units of its left and right neighbour nodes to enable the passing of parity information and, if needed, success/failure information concerning merge operations. Messages on the MC channels 78, 79 are referred to herein as ‘MC’ messages.

The LLEC communication channel 74, 75 and the MC communication channel 78, 79 can be provided over any suitable high-speed communication connections (such as radio) but are preferably carried as optical signals over optical fibres. More particularly, the LLEC communication channel 74, 75 and the MC communication channel 78, 79 can be carried over respective dedicated optical fibres or multiplexed onto the same fibre (which could be the fibre used for the local links optically coupling Q-blocks in neighbouring nodes—for example, the MC communication channel can be implemented as intensity modulations of the herald signal 79, particularly where only parity information is being sent on this channel). More generally, the LLEC and MC communication channels can be combined into a single duplex classical communications channel.

In the embodiments described hereinafter, the LLEC communication channel 74, 75 is carried by the local link fibres and the MC communication channel 78, 79 is carried by optical fibre distinct from that used for the local links. It will be appreciated that this arrangement of channels and fibres is merely exemplary and other arrangements could alternatively be used.

It may be noted that the end nodes linked by a chain of quantum repeaters will each contain functionality for inter-working with the facing side (L or R) of the neighbouring quantum repeater. Thus, the left end node will include functionality similar to that of the R-side of a quantum repeater thereby enabling the left end node to inter-work with the L-side of the neighbouring repeater, and the right end node will include functionality similar to that of the L-side of a quantum repeater to enable the right end node to inter-work with the R-side of the neighbouring repeater.

With regard to entanglement parity, in the embodiments described below, rather than the parity of entanglements being standardized by qubit state flipping, at each quantum repeater LLE parity information is stored and subsequently combined with merge parity information for passing on along cumulatively to an end node thereby to enable the latter to determine the parity of end-to-end entanglements.

In the following description of the quantum repeater embodiments, the same reference numerals are used for the main repeater components as are used in the generic diagram of FIG. 7, it being understood that the specific implementations of these components will generally differ.

### “Quasi Asynchronous” Quantum Repeater Embodiments

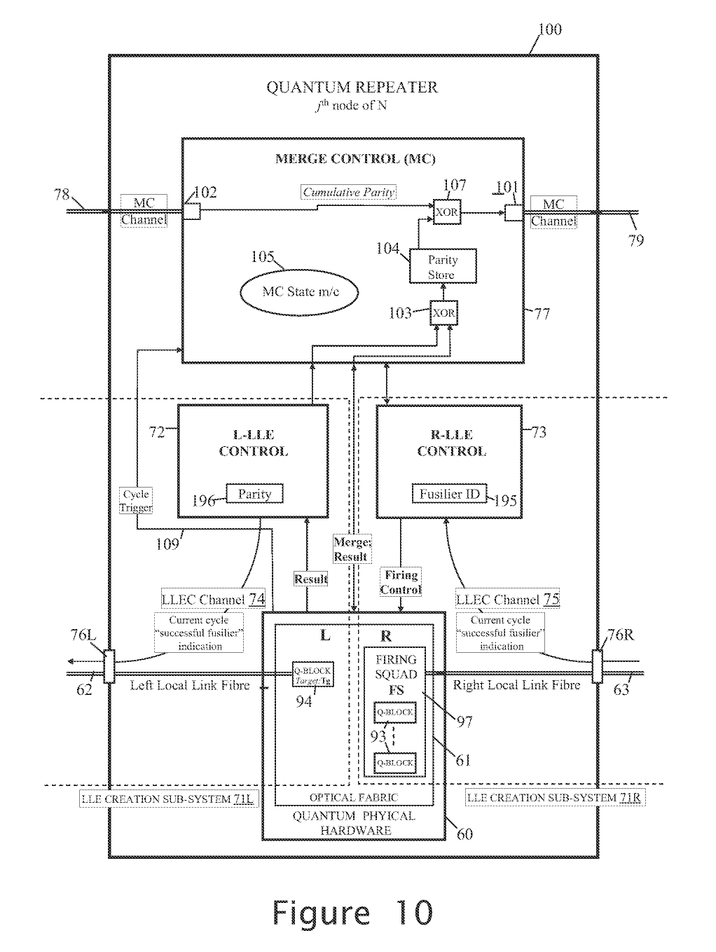

The quantum repeater embodiments described below, and in particular that illustrated in FIG. 10, operate on a “Quasi Asynchronous” basis to build an end-to-end (E2E) entanglement between qubits in left and right end nodes of a chain of nodes whose intermediate nodes are quantum repeaters. Building an E2E entanglement on the “Quasi Asynchronous” basis involves a cycle-trigger signal being propagated along the chain of nodes from one end node thereby to enable each repeater along the chain to carry out one top-level cycle of operation in which it initiates a local merge operation when left and right qubits of the repeater are known to be, or are expected to be, leftward and rightward entangled respectively. Typically, each repeater is responsible for initiating creation of right side LLEs either in response to receiving the cycle-trigger signal or independently thereof. In due course, every repeater will have effected a single merge and this results in an E2E entanglement being created, the whole process constituting an E2E operating cycle. The order in which the repeaters carry out their respective merge operations in an E2E operating cycle is not necessarily the same as the order in which the repeaters receive the cycle-trigger signal but will depend on a number of factors, most notably the spacing between nodes. Further E2E operating cycles can be initiated by the sending out of further cycle-trigger signals. While the top-level operating cycles of any one repeater do not overlap, the E2E operating cycles may do so.

The cycle-trigger signal is sent on by each repeater without waiting for the enabled local merge operation at the repeater to be carried out. Typically, the cycle-trigger signal is sent on by a repeater substantially without delay; however, introduction of a short delay, for whatever reason, is possible and, while not affecting the general process thr creatin E2E entanglement, such a delay could alter the order in which the repeaters carry out their merge operations relative to each other in an E2E, operating cycle.

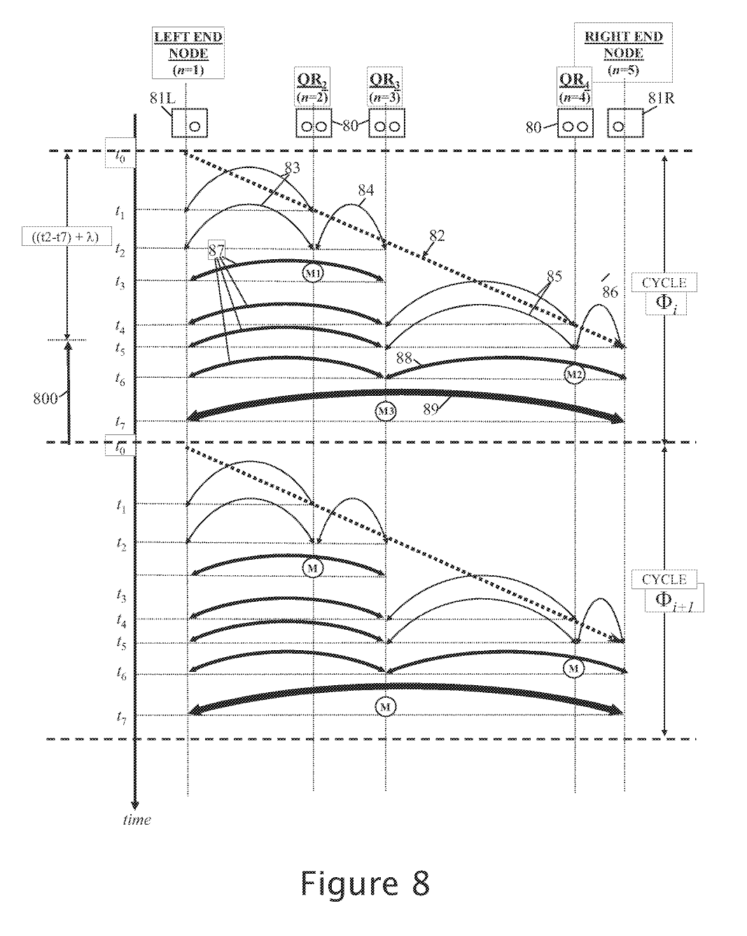

FIG. 8, which uses the same notation as FIG. 3, depicts two successive E2E operating cycles Φ for a chain of five irregularly-spaced optically-coupled nodes comprising left and right end nodes 81L, 81R and three quantum repeaters 80 (QR₂, QR₃, QR₄); the optical fibres coupling the nodes are omitted for clarity. The two E2E operating cycles are labelled Φᵢ and Φᵢ₊₁ respectively each starting at a cycle-relative time of t₀. In the FIG. 8 illustrative example, it is the left end node 81L, which sends out the cycle-trigger signals and each node when it receives a cycle-trigger signal both propagates on the signal and initiates the creation of a right LLE. In this example, the LLE creation subsystems formed by and between neighbouring nodes are ‘reliable’—that is, at each triggering there is a high probability of successfully creating an LLE (“Quasi Asynchronous” operation using non-reliable LLE creation subsystems is described hereinafter with reference to FIG. 21).

Considering what happens in E2E operating cycle Φᵢ, as the cycle-trigger signal propagates along the node chain (indicated by bold dotted line 82) it triggers nodes 81L, QR₂, QR₃ and QR₄, to initiate, at times t₀, t₁, t₂, and t₄ respectively, right LLE creation; corresponding LLEs 83, 84, 85 and 86 come into being at times t₁, t₂, t₄, and t₅ respectively (that is, at the same time as the cycle trigger arrives at the node anchoring the downstream of each LLE—this is because the cycle-trigger signal and the light fields participating in LLE creation are passing between the same nodes at substantially the same time and LLE creation is reliable). While QR₂, QR₃ and QR₄, become aware or assume a left LLE exists from when the cycle-trigger signal is received, it is not until times t₃, t₇, and t₆ respectively that they are informed of right LLE creation and effect their local merge operations. Thus, at time t₃ repeater QR₂ effects its merge (indicated by circled ‘M1’ in FIG. 8) to form extended entanglement 87, at time t₆ repeater QR₄ effects its merge (indicated by circled “M2”) in form extended entanglement 88, and finally at time t₇ repeater QR₃ effects its merge (indicated by circled ‘M3’) to combine extended entanglements 87 and 88 into E2E entanglement 89.

As can be seen, the order of the repeaters carrying out their respective merge operations differs from the order of the repeaters along the chain.

Although the second E2E operating cycle Φᵢ₊₁; is depicted in FIG. 8 as starting after the first cycle has completed (as judged by creation of the E2E entanglement 89), it is in fact possible to overlap the cycles as indicated by arrow 800, the degree of overlap being such as to avoid the overlapping of the individual repeater operating cycles plus a safety margin λ. In the FIG. 8 example, repeater QR3 has the longest operating cycle (it waits the longest to know that right LLE creation has been successful, namely for the period t₂−t₇); the start of the second E2E operating cycle Φᵢ₊₁ is therefore arranged to occur a time delay of ((t₇−t₂)+λ) relative to the start of the first E2E operating cycle Φᵢ.

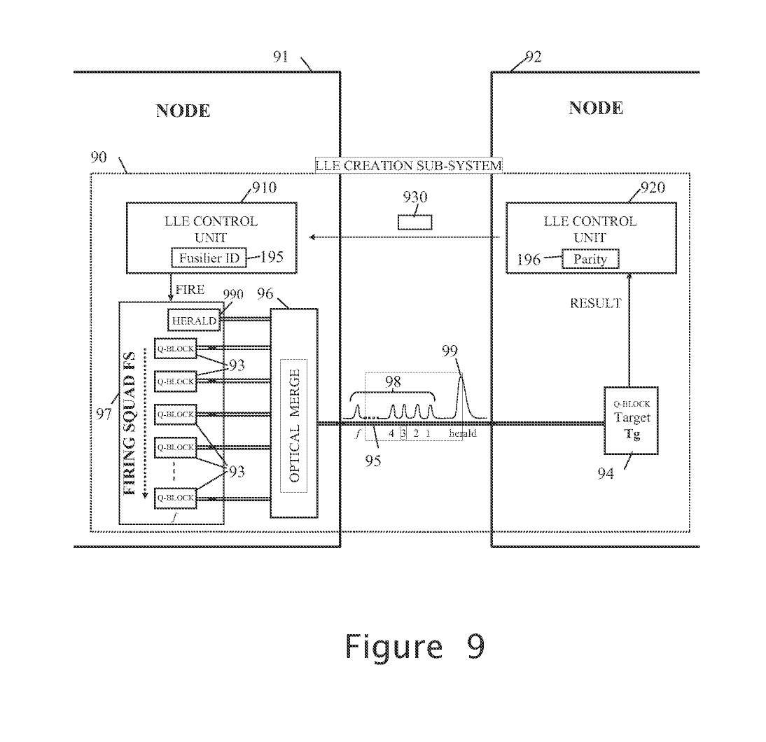

A suitable form for the repeaters QR₂, QR₃ and QR₄ is that of the quantum repeater embodiment described below with reference FIG. 10, this embodiment including components for forming ‘reliable’ LLE creation subsystems with neighbour nodes. Before proceeding to a description of the FIG. 10 quantum repeater embodiment, it is convenient first to describe a suitable form of ‘reliable’ LLE creation subsystem. Of course, with long enough operating periods for multiple firings and/or favourable operating conditions (such as a short distance between nodes), even a simple LLE creation subsystem such as depicted in FIG. 5 (or multiple paralleled subsystems of that form) can create LLEs with high probability. However, for multi-kilometre inter-node distances and operating periods of the order of 10⁻⁶ s, the simple LLE creation subsystem depicted in FIG. 5 is unlikely to be adequate whereas the LLE creation subsystem now to be described with reference to FIG. 9 offers much higher reliability.

### “Firing Squad” LLE Creation Subsystem

FIG. 9 depicts a “firing squad” form of LLE creation subsystem 90 formed between two nodes 91 and 92 that are optically coupled by local link fibre 95.

The node 91 comprises an LLE control unit 910, and quantum physical hardware formed by ƒQ-blocks 93 (with respective IDs 1 to ƒ) that have Capture interaction functionality, and an optical merge unit 96. The Q-blocks 93 (herein “fusilier” Q-blocks) collectively form a “firing squad” 97. The node 92 comprises an LLE control unit 920, and quantum physical hardware formed by a single Q-block 94 with Transfer interaction functionality. The fusilier Q-blocks 93 of the firing squad 97 of node 91 are optically coupled through the optical merge unit 96 and the local link optical fibre 95 to the single target Q-block 94 of node 92. Thus, as can be seen, all the Q-blocks 93 of the firing squad 97 are aimed to fire at the same target Q-block 94.

When the LLE control unit 910 of node 91 outputs a Fire signal to its quantum physical hardware to trigger an LLE creation attempt, the Q-blocks 93 of the firing squad 97 are sequentially fired and the emitted light fields pass through the merge unit 96 and onto the fibre 95 as a light-field train 98, it may be noted that there will be an orderly known relationship between the fusilier Q-block Ms and the order in which the light fields appear in the train. Rather than each light field being preceded by its own herald, a single herald 99 preferably precedes the light-field train 98 to warn the target Q-block 94 of the imminent arrival of the train 98, this herald 99 being generated by emitter 990 in response to the Fire signal and in advance of the firing of the fusilier Q-blocks 93.

As each light field arrives in sequence at the target Q-block 94 of node 92, the shutter of the target Q-block is briefly opened to allow the light field to pass through the qubit of the target Q-block to potentially interact with the qubit, the light field thereafter being measured to determine whether an entanglement has been created, if no entanglement has been created, the qubit of target Q-block 94 is reset and the shutter is opened again at a timing appropriate to let through the next light field of the train 98. However, if an entanglement has been created by passage of a light field of train 98, the shutter of the target Q-block is kept shut and no more light fields from the train 98 are allowed to interact with the qubit of target Q-block 94. The measurement-result dependent control of the Q-block shutter is logically part of the LLE control unit 920 associated with the target Q-block 94 though, in practice, this control may be best performed by low-level control elements integrated with the quantum physical hardware.

It will be appreciated that the spacing of the light fields in the train 98 should be such as to allow sufficient time for a determination to be made as to whether or not a light field has successfully entangled the target qubit, for the target qubit to be reset, and for the Q-block shutter to be opened, before the next light field arrives.

In fact, rather than using an explicit shutter to prevent disruptive interaction with the target qubit of light fields subsequent to the one responsible for entangling the target qubit, it is possible to achieve the same effect by transferring the qubit state from electron spin to nuclear spin immediately following entanglement whereby the passage of subsequent light fields does not disturb the captured entangled state (the target qubit having been stabilized against light-field interaction). It may still be appropriate to provide a shutter to exclude extraneous light input prior to entanglement but as the qubit is not set into its prepared state until the herald is detected, such a shutter can generally be omitted.

The LLE control unit 920 is also responsible for identifying which light field of the train successfully entangled the target qubit of Q-block 94 and thereby permit identification of the fusilier Q-block 93 (and thus the qubit) entangled with the target Q-block cubit (as already noted, there is a known relationship between the fusilier Q-block IDs and the order in which the light fields appear in the train). For example, the light fields admitted to the target Q-block may simply be counted and this number passed back by the LLE control unit 920 to the node 91 in a ‘success’ form of a message 930, the LLE control unit 910 of node 91 performing any needed conversion of this number to the ID number of the successful fusilier Q-block 93 before storing the latter in a register 195 for later reference (alternatively, the fusilier ID may be passed on immediately). Of course, if none of the light fields of train 98 is successful in creating an entanglement, a ‘fail’ form of message 930 is returned and a corresponding indication stored in register 195.

With regard to the parity information contained in the measurement result in respect of the successful entanglement of the target qubit, this parity information is passed to the control unit 920 which may either store it for later use (for example in a register 196) or pass it on, for example to node 91 in the message 930.

Rather than sequentially firing the fusilier Q-blocks 93 of node 91 to produce the train of light fields 98, an equivalent result can be achieved by firing them all together but using different lengths of fibre to connect each fusilier Q-block to the optical merge unit 96, thereby introducing different delays and creating the light-field train 98.

The number of fusilier Q-blocks 93 in the firing squad 97 is preferably chosen to give a very high probability of successfully entangling target Q-block 94 at each firing of the firing squad, for example 99% or greater. More particularly, if the probability of successfully creating an entanglement with a single firing of a single fusilier Q-block is s, then the probability of success for a firing squad of f fusilier Q-blocks will be:

Firing squad success probability=1−(1−s)^{f}

whereby for s=0.25, 16 fusilier Q-blocks will give a 99% success rate and 32 fusilier Q-blocks a 99.99% success rate. Typically one would start with a desired probability P_{success} of successfully entangling the target qubit with single firing (i.e. a single light-field train) and then determine the required number f of fusilier qubits according to the inequality:

P_{success}≦(1−1−s)^{f}

The time interval between adjacent light fields in the train 98 is advantageously kept as small as possible consistent with giving enough time for the earlier light field to be measured, the target qubit reset and its shutter opened before the later light field arrives. By way of example, the light fields are spaced by 1-10 nanoseconds.

It will be appreciated that with the FIG. 9 form of LLE creation sub-system 90, because there is only one target Q-block 94, the firing squad 97 cannot in practice be re-triggered until the whole sub-system is freed up by the most recently created entanglement being consumed or timing out (or otherwise ceasing to be of use). The minimum time between triggering of the firing squad 97 is thus the round trip time between the nodes (that is, the minimum time for the light train 98 to reach node 92 and for message 930 to be returned to node 91) plus a time for consuming the entanglement (for example, in a merge operation).

### First “Quasi Asynchronous” Quantum Repeater Embodiment (FIG. 10)

The first “Synchronized” quantum repeater embodiment will now be described, with reference to FIG. 10, it being understood that the quantum repeater operates in the context of being an intermediate node in a chain of N nodes (such as depicted in FIG. 8 for N=5) between the left and right end nodes of which E2E entanglements are to be created.

The general form of the FIG. 10 quantum repeater corresponds to that shown in FIG. 7, and comprises: quantum physical hardware 60; left and right local link fibres 62, 63, interfacing via optical interfaces 76L, 76R; L-side and R-side LLE control units 72, 73 and merge control unit 77.

The quantum physical hardware 60 (depicted in the generalized manner explained with respect to FIG. 6) comprises;
a L-side (left-side) target Q-block 94 that forms part of a left LLE creation subsystem 71L;
multiple R-side fusilier Q-blocks 93 that forty the firing squad 97 of a right LLE creation subsystem 71R; and
an optical fabric 61 coupled to left and right local ink fibres 62, 63.

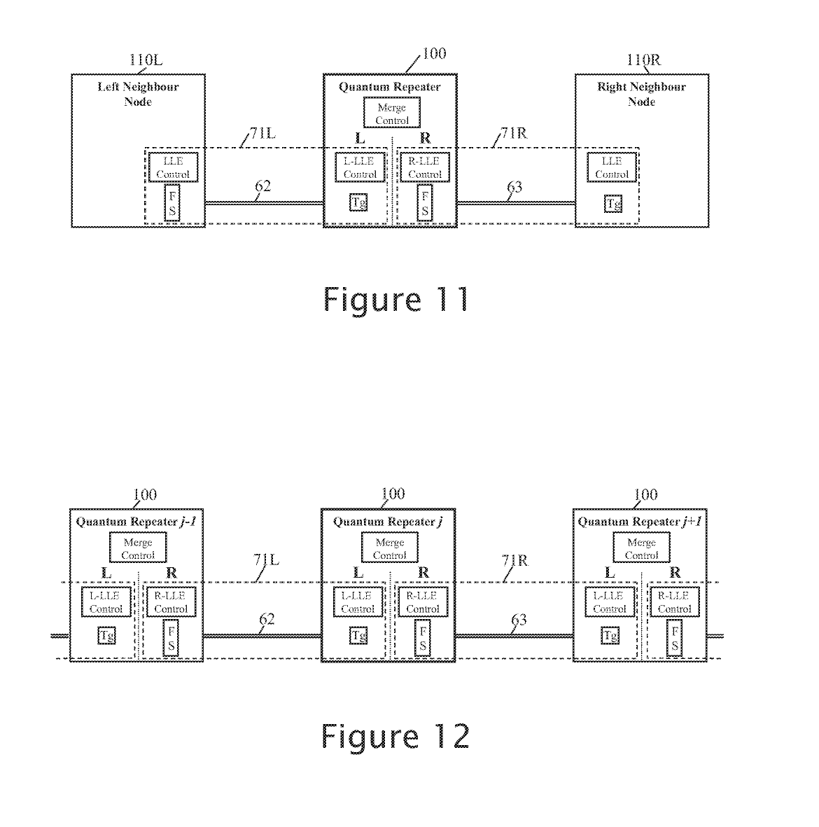

The left and right LLE creation subsystems 71L, 71R are substantially of the form illustrated in FIG. 9 for LLE creation subsystem 90. As graphically depicted in FIG. 11, the left LLE creation subsystem 71L comprises:
(a) in repeater 100, the above-mentioned L-side elements of the quantum physical hardware 60 (in particular, the target Q-block 94, depicted in FIG. 11 by a box with the letters ‘Tg’ inside), anal the left LLE (L-L E) control unit 72 parity register 196;
(b) the left local link fibre 62; and
(c) in a left neighbour node 110L, a firing squad of fusilier Q-blocks 93 (depicted in FIG. 11 by a box with the letters ‘FS’ inside) and its associated optical fabric and LLE control unit.

The right LLE creation subsystem 71R comprises:
(a) in repeater 100, the above-mentioned R-side elements of the quantum physical hardware 60 (in particular, the firing squad 97 depicted in FIG. 11 as box ‘FS’), and the right LLE (R-LLE) control unit 73 with fusilier ID register 195;
(b) the right local link fibre 63; and
(c) a right neighbour node 110R, a target Q-block (box ‘Tg’) and its associated optical fabric and LLE control unit.

With this arrangement of complementary firing squad and target portions of a FIG. 9 LLE creation subsystem 90, multiple quantum repeaters 100 can be optically coupled in series such as to form one LLE creation subsystem between every pairing of neighbouring repeaters as is illustrated in FIG. 12 for quantum repeaters j−1, j, j+1 (the quantum repeater j firming an LLE creation subsystem 71L with its left neighbour repeater j−1 and an LLE creation subsystem 71R with its right neighbour repeater j+1).

The optical fabric 61 of the quantum repeater 100, as well as coupling the L-side and R-side Q-blocks 94, 93 to the left and right local link fibres 62, 63 respectively for LLE creation, also provides for the selective optical coupling of the L-side target Q-block 94 to a selected one of the R-side fusilier Q-blocks 93 for the purpose of effecting a local merge operation on the qubits of these Q-blocks.

During LLE creation, the quantum physical hardware 60 receives firing control signals from the R-LLE control unit 73 for controlling the R-side elements (in particular, the triggering of the firing squad 97), and outputs result signals (success/failure; parity; fusilier-identifying information) from the L-side target Q-block 94 to the L-LLE control unit 72. For a local merge operation, the quantum physical hardware 60 receives merge control signals from a merge control unit 77 (these signals selecting the fusilier Q-block 93 that is to participate in the merge, and triggering the merge itself), and outputs back to the unit 77 results signal (success/failure; parity) regarding the outcome of the merge operation.

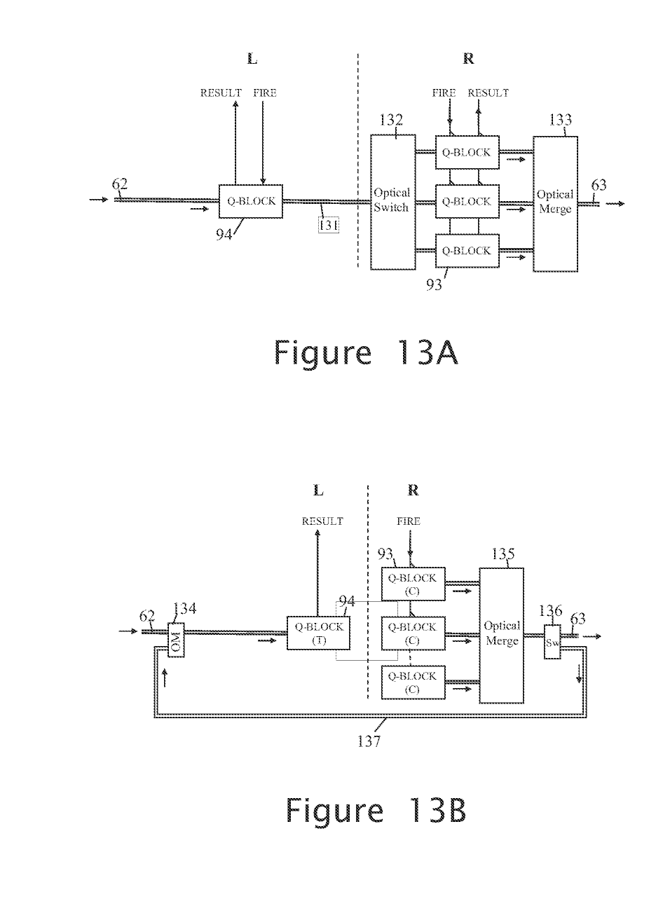

FIGS. 13A and 13B illustrated two possible implementations of the optical fabric 61 depending on the nature of the Q-blocks 93 and 94.

The FIG. 13A optical fabric implementation is applicable to the case where the fusilier and target Q-blocks 93, 94 are universal Q-blocks 44 (c.f. FIG. 4). In this case, the left local link fibre 62 interfaces directly with the optical input of the target universal Q-block 94, and the optical output of this universal Q-block is optically coupled to an intermediate optical fibre 131. An active optical switch 132 interfaces the intermediate fibre 131 with the inputs of the fusilier universal Q-blocks 93 and a passive optical merge unit 133 puts the outputs of the fusilier Q-blocks 93 onto the right local link fibre 63. During LLE creation operation, the target Q-block 91 is set up for Transfer interaction and light fields coming in over the left link fibre 62 are fed to the target Q-block; the fusilier Q-blocks 93 are set up for Capture interaction and the optical merge unit 133 couples the fusilier Q-blocks 93 to the right local link fibre 63. For a merge operation, the target Q-block 91 is set up for Capture interaction and the fusilier Q-block involved in the merge is set up for Transfer interaction (the fusilier Q-block concerned will have been indicated in the merge set-up signals fed to the quantum physical hardware 60); the optical switch 132 is also set by the merge set up signals to optically couple the target Q block 94 to the fusilier Q-blocks 93 involved in the merge.

The FIG. 13B optical fabric implementation is applicable to the case where the target Q-block 94 is a Transfer Q-block 42 (c.f. FIG. 4) and the fusilier Q-blocks 93 are Capture Q-blocks 40. In this case, a passive optical merge unit 135 puts the outputs of the fusilier Capture Q-blocks 94 onto a single fibre which is then switched by an active optical switch 136 either to the right local link fibre 63 or to a loop-back optical fibre 137. A passive optical merge unit 134 fronts the target Transfer Q-block 93, the optical merge unit 134 being coupled on its input side to the left local link fibre 62 and the loop-back optical fibre 137. For an LLE creation operation, the optical switch 135 is set to feed the light fields output by the fusilier Capture Q-blocks 93 to the right local link fibre 63. For a merge operation, the optical switch 135 is set to feed the light field output by a selected one of the fusilier Capture Q-blocks 93 to the loop-back fibre 137 (the Q-block concerned will have been indicated in the merge set-up signals fed to the quantum physical hardware 60).

Returning to a consideration of FIG. 10, the left LLE control unit 72 associated with the L-side target Q-block 94 of LLE creation subsystem 71L, communicates with the firing-squad-associated LLE control unit of the same LLE creation subsystem (this control unit being in the left neighbour node) via left LLEC channel 74. In the present example embodiment, the left LLEC channel 74 is imposed on the left local link fibre 62 via optical interface 76L and used to pass LLE creation “success/failure” messages (the message 930 of FIG. 9 with fusilier ID being included as appropriate) from the L-LLE control unit 72 to the LLE control unit of the left neighbour node.

Similarly, the right LLE control unit 73 associated with the R-side fusilier Q-blocks 93 of the firing squad 97 of LLE creation subsystem 71R, communicates with the target-associated LLE control unit of the same LLE creation subsystem (this control unit being in the right neighbour node) via right LLEC channel 75. The right LLEC channel 75 is imposed on the right local link fibre 63 via optical interface 76R and used to pass, to the R-LLE control unit 73, LLE creation “success/failure” messages (the message 930 of FIG. 9 with fusilier ID as appropriate) from the LLE control unit of the right neighbour node.

Merge control is effected by merge control (MC) unit 77 which, as well as interfacing with the quantum physical hardware to initiate a merge operation and receive back result signals, is arranged to exchange various signals with the L-LLE control unit 72 and R-LLE control unit 73 and to communicate with the merge control units of other nodes by messages sent over MC channel 78, 79 here carried by left and right optical fibres that are couple to the MC unit 77 through respective interfaces 101, 102. With the present embodiment, it is the responsibility of the entanglement consumer applications to detect any failures to create E2E entanglements; accordingly, there is no requirement to send merge success/failure messages over the MC channels. The main role of the MC channel in this embodiment is simply to carry cumulative parity messages each concerning a respective E2E operating cycle Φ.

Regarding the cycle-trigger signal that is propagated between repeater nodes to trigger a cycle of operation, it is possible to send this signal over any appropriate channel between the nodes. However, since in the present embodiment each repeater top-level operating cycle starts with the firing squad 97 of the repeater 100 being triggered to fire a light-field train 98 (see FIG. 9) preceded by a herald 99, towards its right neighbour node, it is convenient to use the herald 99 as the cycle-trigger signal. Thus, when a herald 99 is received at the target end of a repeater's left LLE creation subsystem 71L, it is extracted and passed over line 109 to the MC unit 77 to trigger a cycle of operation (described below), this cycle starting with the triggering of the firing squad 97 of the repeater's right LLE creation subsystem 71R thereby propagating on the cycle-trigger as the held 99 sent out by this subsystem.

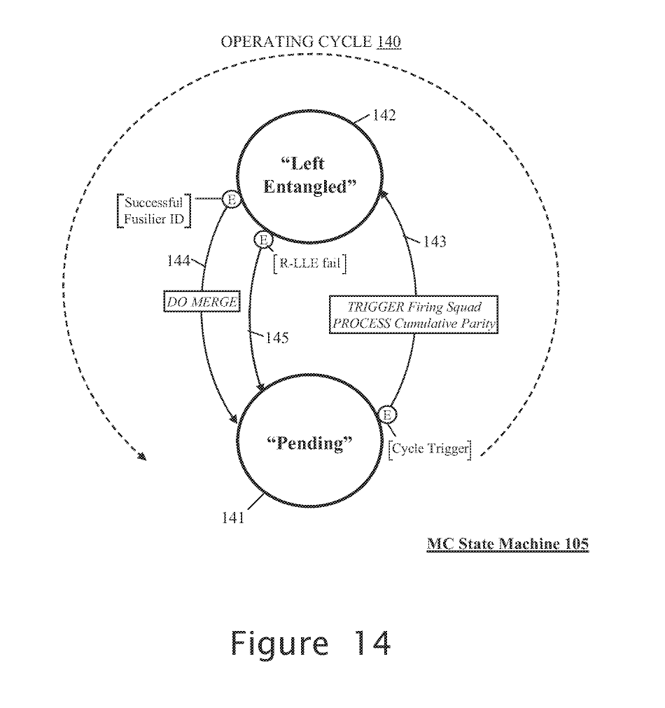

A cycle of operation of the MC control unit 77 will next be described in terms of an example implementation of a controlling state machine 105 with FIG. 14 showing a state transition diagram for this state machine. In this state transition diagram, states are shown by bold-edged circles, state transitions are shown by arrowed arcs, events that trigger transition from a state are indicated by circled ‘E’s and associated square-bracketed legends indicating the nature of the events concerned, and actions taken upon a state transition being triggered by an event are indicated in rectangular boxes placed on the relevant state transition arc.

After completion of a previous cycle of operation and prior to receipt of a next cycle-trigger signal (herald 99), the state machine 105 resides in a Pending state 141. In due course, a cycle-trigger signal is received causing the state machine to transition to a “Left Entangled” state 142 (see arc 143), the assumption being that a left LLE can be expected now to exist (or imminently will do so) as the cycle trigger is indicative of the left LLE creation subsystem 71L having been operated, in transitioning to state 142, the state machine 105 triggers (via R-LLE control unit 73) the firing of the firing squad 97 of the right LLE creation subsystem 71R; in addition, state machine 105 causes the rightward transmission on its MC channel 79 of a cumulative parity message in respect of the preceding operating cycle of the repeater (this will be more fully described hereinafter).

In due course, the R-LLE control unit 73 receives an indication of the successful fusilier ID or a failure indication in respect of the attempted right LLE creation. The received indication is passed to the MC unit 77 and causes the state machine to transition back to its Pending state 141. If the received indication is that of a successful fusilier ID, the transition to state 141 is via arc 144 resulting in the initiation of a local merge operation between the left-side target qubit and the identified right-side fusilier qubit. However, if the received indication is one of failure, the transition to state 141 is via arc 145 resulting in merge initiation being skipped.

The above-described cycle 140 of transition from Pending state 141 to Left-Entangled state 142 and back again defines the top-level operating cycle of the quantum repeater 100, one execution of the cycle resulting in at most one merge operation being effected.

In addition to the control functionality represented by state machine 105, the MC unit 77 includes functionality for handling parity information. More particularly, following each local merge operation the MC unit receives merge parity information from the quantum physical hardware 60. This merge parity information is first combined by an exclusive OR operation (functional box 103 in FIG. 10) with LLE parity information retrieved from the register 196 before being stored to parity store 104. Upon transition to state 142 on arc 143 during the next top-level repeater operating cycle, this local parity information stored in parity store 104 is combined through XOR function 107 into cumulative parity information received in an MC message from the left neighbour node; the new cumulative parity information is then sent on to the right neighbour node in an MC message. It should be noted that the two parity bits of each item of parity information are treated independently by the above-mentioned XOR functions.

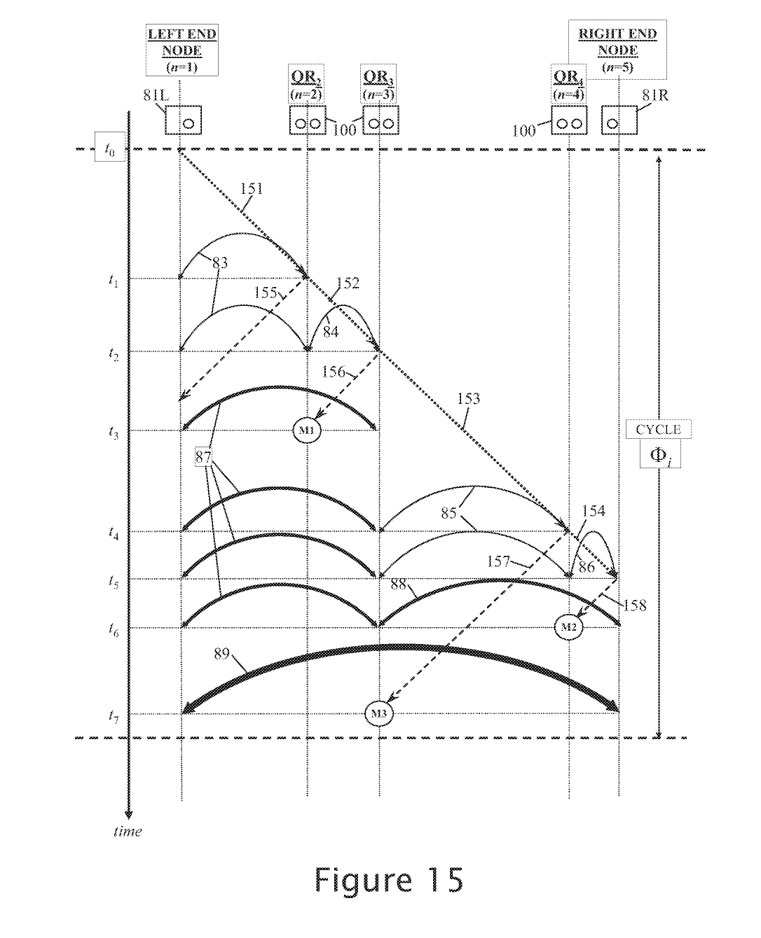

Operation of the FIG. 8 node chain over the course of a single E2E operating cycle will now be described in more detail for the case of the repeaters QR₂, QR₃, QR₄ being of the FIG. 10 form (and therefore referenced 100); this description will be given with reference to FIG. 15 which is an enlargement (time axis expanded by a factor of two) of the FIG. 8 depiction of E2E operating cycle Φᵢ. The same references 83-89 are used in FIG. 15 as in FIG. 8 to refer to the various entanglements created in the course of the cycle Φᵢ. The propagation of the cycle trigger that was represented in FIG. 8 by bold dotted arrow 82, is represented in FIG. 15 by four dotted arrows 151-154 to correspond to the heralds 99 sent out in turn by nodes 81L, QR₂, QR₃, QR₄ respectively. Newly shown in FIG. 15 are the return messages sent by the L-LLE control units 73 of nodes QR₂, QR₃, QR₄ and 81R to their left neighbour nodes providing an indicator of the successful fusilier ID or of LLE creation failure; these return messages sent from nodes QR₂, QR₃, QR₄ and 81R are represented by dashed arrows 155, 156, 157 and 158 respectively.

Cycle Φᵢ proceeds as follows:
At time t₀—the left end node 81L starts a new cycle by initiating creation of a right LLE thereby also sending out a cycle-trigger (dotted arrow 151) towards QR₂.
At time t₁—the cycle-trigger signal from node 81L reaches repeater node QR₂ and LLE 83 is successfully created between left end node 81L and node QR₂; QR₂ assumes or knows of the existence of LLE 83 at this point. QR₂ initiates creation of a right LLE thereby also sending out a cycle-trigger (dotted arrow 152) towards QR₃. In addition, QR₂ sends a message to node 81L about the creation of LLE 83 (dashed arrow 155).
At time t₂—the cycle-trigger signal from repeater node QR₂ reaches repeater node QR₃ and LLE 84 is successfully created between repeater nodes QR₂ and QR₃; although QR₃ assumes or knows of the existence of LLE 84 at this point, QR₂ is not yet aware. QR₃ initiates creation of a right LLE thereby also sending out a cycle-trigger (dotted arrow 153) towards QR₄. In addition, QR₃ sends a message to node QR₂ about the creation of LLE 84 (dashed arrow 156).
At time t₃—repeater node QR₂ becomes informed of the existence of right LLE 84 and therefore knows it can effect a local merge which it proceeds to do (circled ‘M1’) thereby combining LLEs 83, 84 to form extended entanglement 87.
At time t₄—the cycle-trigger signal from repeater node QR₃ reaches repeater node QR₄ and LLE 85 is successfully created between repeater nodes QR₃ and QR₄; although QR₄ assumes or knows of the existence of LLE 85 at this point, QR₃ is not yet aware. QR₄ initiates creation of a right LLE thereby also sending out a cycle-trigger (dotted arrow 154) towards end node 81R. In addition, QR₄ sends a message to node QR₁ about the creation of LLE 85 (dashed arrow 157).
At time t₅—the cycle-trigger signal from repeater node QR₄ reaches right end node 81R and LLE 86 is successfully created between repeater node QR₃ and end node 81R; although end node 81R assumes or knows of the existence of LLE 86 at this point, QR₄ is not yet aware. End node 81R sends a message to node QR₄ about the creation of LLE 86 (dashed arrow 158).

At time t₆—repeater node QR₄ becomes informed of the existence of right LLE 86 and therefore knows it can effect a local merge which it proceeds to do (circled ‘M2’) thereby combining LLEs 85, 86 to form extended entanglement 88.
At time t₇—repeater node QR₃ becomes informed of the existence of right LLE 85 and therefore knows it can effect a local merge which it proceeds to do (circled ‘M3’) thereby combining the extended entanglements 87, 88 to form E2E entanglement 89.

As regards the cumulative parity information, this passes along the chain of nodes in a left-to-right MC message propagated substantially in coordination with the cycle-trigger signal; the cumulative parity information in each such message relates to the preceding E2E operating cycle rather than to the cycle currently being executed. As already indicated, the MC channel can be carried by intensity modulations of the heralds 99 and in this case, the heralds not only serve their basic warning purpose but also serve as the cycle-trigger signal for the current E2E operating cycle and the carrier of the cumulative parity information for the preceding E2E operating cycle. Since the MC channel is only used in the FIG. 10 embodiment for conveying the cumulative parity messages, using the heralds to carry these messages means that the entangling light fields and all signalling are carried over the local fibres and no other optical fibres are needed.

With regard to the left and right end nodes between which the E2E entanglements are created, these nodes are not themselves quantum repeaters though, of course, they comprise functionality for completing the LLE creation subsystems involving their respective neighbour quantum repeaters, and functionality for sending/receiving the MC cumulative parity messages. In the present example, where the firing squads 97 fire left to right along the node chain, the left end node also initiates E2E operating cycles by sending out a cycle-trigger signal (in the present example by triggering its firing squad 97) at regular intervals.

The left and right end nodes also serve a further function, namely to free up at the end of each E2E operating cycle the entangled end-node LLE creation subsystem qubits between which an E2E has just been formed. This is done by providing each end node with an output buffer comprising multiple Q-blocks and shifting each newly created E2E entanglement across into qubits of the buffers pending their consumption by consumer applications associated with the end nodes. Of course, such buffering may not be required where the consumer applications are arranged to consume E2E entanglements as they become available at the end of each operating cycle and can tolerate the loss of such entanglements if not timely consumed.

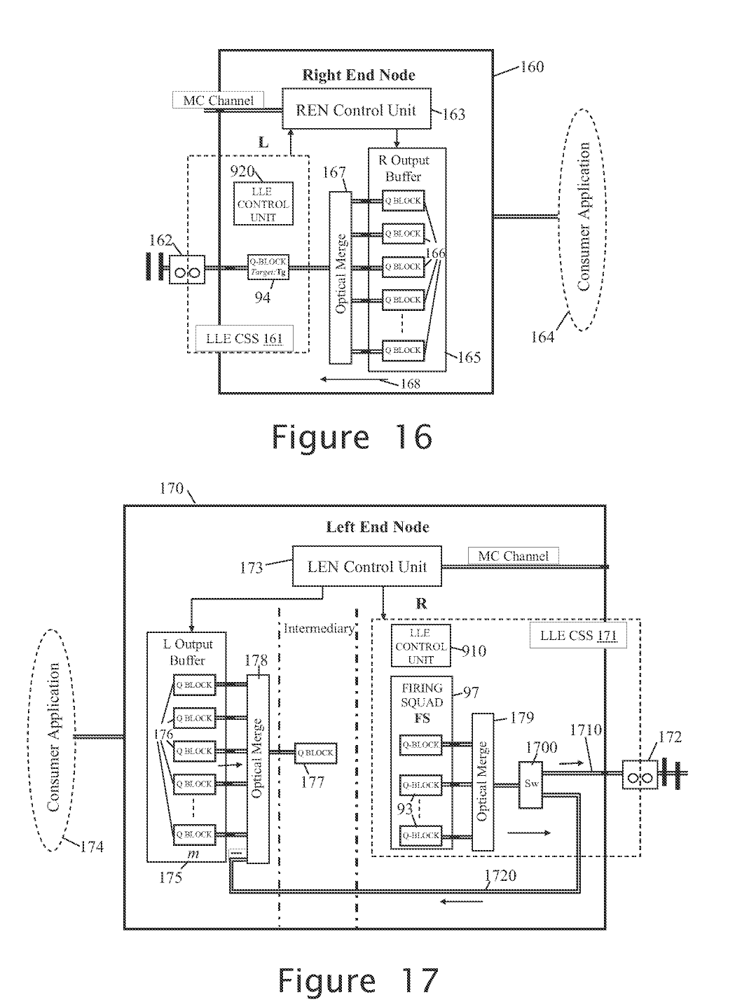

FIGS. 16 and 17 depict example implementations 160 and 170 of right and left end node respectively.

The right end node 160 shown in FIG. 16 comprises:
a target Q-block 94 and associated LLE control unit 920 of an LLE creation subsystem 161 formed with left neighbour quantum repeater node 162;
a high-level right end node (REN) control unit 163 arranged to receive the cycle-trigger signal to enable it to track the E2E cycles; the control unit 163 interfaces with the MC channel fibre and receives MC cumulative parity messages;
an output buffer 165 comprising multiple Q-blocks 166 into a selected one of which the end of an entanglement rooted in target Q-block 94 can be shifted (this is done under the control of REN control unit 163 at the end of the relevant operating cycle).

The right end node 160 also interfaces with a local E2E entanglement consumer application 164 (shown dashed).

FIG. 16 depicts a particular optical fabric implementation that uses an optical merge unit 167 to couple the buffer Q-blocks 166 to the target Q-block 94. The buffer Q-blocks 166 have Capture interaction functionality and the target Q-block 94 already possesses the required Transfer interaction capability. To transfer the right end root of an E2E entanglement from the target Q-block 94 to a particular buffer Q-block 166, the latter is first entangled with the target Q-block 94 by an entanglement operation; this is effected by selectively energizing (under the control of REN control unit 163) the emitter associated with the buffer Q-block 166 concerned thereby causing a light field to traverse the qubit of that Q-block before being channeled by the optical merge unit 167 to the target Q-block 94 (as generally indicated, by arrow 168). Thereafter, the target Q-block 94 is removed from entanglement by an X measurement operation. As theses operations are carried out over a short distance, the probability of success is high.

The REN control unit 163 is responsible for keeping track of which buffer Q-blocks 166 are currently entangled and also to correctly associate the cumulative parity information received in MC messages with the relevant buffer Q-block 166.

The left end node 170 shown in FIG. 17 comprises:
a firing squad 97 with fusilier Q-blocks 93, and associated LLE control unit 910 of an LLE creation subsystem 171 formed with right neighbour quantum repeater node 172;
a high-level left end node (LEN) control unit 173 that includes a master clock (not separately shown) for triggering the firing squad at regular intervals; the control unit interfaces with the MC channel fibre and sends out a cumulative parity message at the start of each E2E operating cycle (this message will only include parity information on the right LLE as the end node does not perform a local merge);
an output buffer 175 comprising in Q-blocks 176 into a selected one of which the end of an entanglement rooted in a fusilier Q-block 93 can be shifted (this is done under the control of LEN control unit 173 at the end, of each E2E operating cycle).

The left end node 170 also interfaces with a local E2E entanglement consumer application 174 (shown dashed).

FIG. 17 depicts a particular optical fabric implementation for coupling a selected one of the fusilier Q-blocks 93 to a particular buffer Q-block 176. The depicted optical fabric implementation avoids the use of an f×m optical switch that would otherwise be required to interface the f fusilier Q-blocks 93 with the m Q-blocks of the output buffer 175, this being achieved through the provision of an intermediary Q-block 177.

More particularly, in the FIG. 17 implementation, the f fusilier Q-blocks 93 are optically coupled through an optical merge unit 179 and local link fibre 1710 to the repeater node chain. The fusilier and buffer Q-blocks 93 and 176 all have Capture interaction functionality whereas the intermediary Q-block 177 has Transfer interaction capability. A 1×2 optical switch 1700 enables the output of the optical merge unit 179 to be switched between the local link fibre 1710 and a loopback fibre 1720 that feeds an input of an optical merge unit 178; the outputs of the buffer Q-blocks are also coupled as inputs to the optical merge unit 178. The output of the optical merge unit 178 is coupled to the intermediary Q-block 177. This arrangement permits any selectively-fired one of the fusilier Q-blocks 93 or any selectively-fired one of the output-buffer Q-blocks 176 to be coupled to the intermediary Q-block 177. As a result, the left end of an E2E entanglement anchored in one of the fusilier Q-blocks 93 can be shifted across to the intermediary Q-block 177 and from there shifted into a selected one of the output-buffer Q-blocks 176, both shills being effected by an elongate operation (see FIG. 1B); alternatively, the selected output-buffer Q-block 176 can first be entangled with the intermediary Q-block 177 and a merge operation then effected between the latter and the fusilier Q-block 93 anchoring the E2E entanglement.

The LEN control unit 173 is responsible for controlling the selection of fusilier Q-block and buffer Q-block involved in the transfer of an E2E entanglement into the buffer 175, and for keeping track of which buffer Q-blocks 176 are currently entangled.

It will be appreciated that different optical fabric implementations are possible for the left and right end nodes to those illustrated in FIGS. 16 and 17; for example, to reverse the light-field direction of travel 168 in the right end node, an active optical switch could be used to optically couple the target Q-block 94 to a selected buffer Q-block 166 (in this case, the target Q-block 94 would need Capture interaction capability and the buffer Q-blocks 166 would need Transfer interaction capability).

It will further be appreciated that associated with the operation of moving an E2E entanglement into a buffer Q-block, will be one or more parity measurements. If a measured parity is even, no further action is needed as the parity of the E2E entanglement unchanged; however, if a measured parity is odd, then to keep the E2E entanglement the same, the buffer qubit concerned is flipped.

Various modifications, additional to those already alluded to above, can be made to the FIG. 10 quantum repeater embodiment. For example:
Right-to-left LLE creation. As already indicated, the terms “left” and “right” are simply convenient labels for relative directions along the node chain. The FIG. 10 embodiment could equally as well been described in terms of the cycle-trigger signal and the light-field trains 98 passing from right to left in the LLE creation subsystems (in which case, for LLE creation, the repeater L-side comprises fusilier Q-blocks and the repeater R-side is a target Q-blocks). Not only is this feasible in the case of the direction of propagation of the cycle-trigger signal also being reversed to be from right to left, but also in the case of the cycle-trigger signal remaining propagated from left to right (although obviously the heralds 99 could not then be used as the cycle-trigger signal); however, in this latter case, after receiving the cycle-trigger signal, each repeater must wait the longest round trip time to its two neighbours before it is in a position to carry out a merge operation.
Passing LLE Parity Information to Firing-Squad End of LLE Creation Subsystem. Rather than LLE parity information being held in register 196 of the LLE control unit 920 at the target end of each LLE creation subsystem, this parity information could be passed in message 930 to the LLE control unit 910 at the firing-squad end the LLE creation subsystems for storage in register 195. After the merge operation in the same cycle, this parity information would them be XORed with the merge parity information for storage in the parity store 104.
Complimentary Repeater Varieties. A hybrid form of quantum repeater, with two complimentary varieties, is possible in which the direction of travel of the light-field train 98 during LLE creation, is opposite for the left and right sides of the repeater. Thus, as depicted in FIG. 18, in one variety 180 of this hybrid repeater, light-field trains 98 are generated by the left and right side firing squads 97 of the repeater variety 180 and after passage through L and R fusilier Q-blocks respectively, are sent out over left and right local link fibres to the left and right neighbour nodes; in the other variety 185 of this hybrid repeater, light-field trains 98 are received by the left and right sides of the repeater variety 185 over left and right local link fibres respectively from the left and right neighbour nodes, are passed through L and R target Q-blocks 94 respectively, and are then measured. It will be appreciated that in a chain of quantum repeaters of the foregoing hybrid form, it is necessary to alternate the two varieties of repeater 180, 185 in order to create LLE creation subsystems it will also be appreciated that the cycle trigger is best implemented independently of the heralds 99 and that the repeater variety 185 must wait the longest round trip time to its two neighbours before it is in a position to carry out a merge operation.

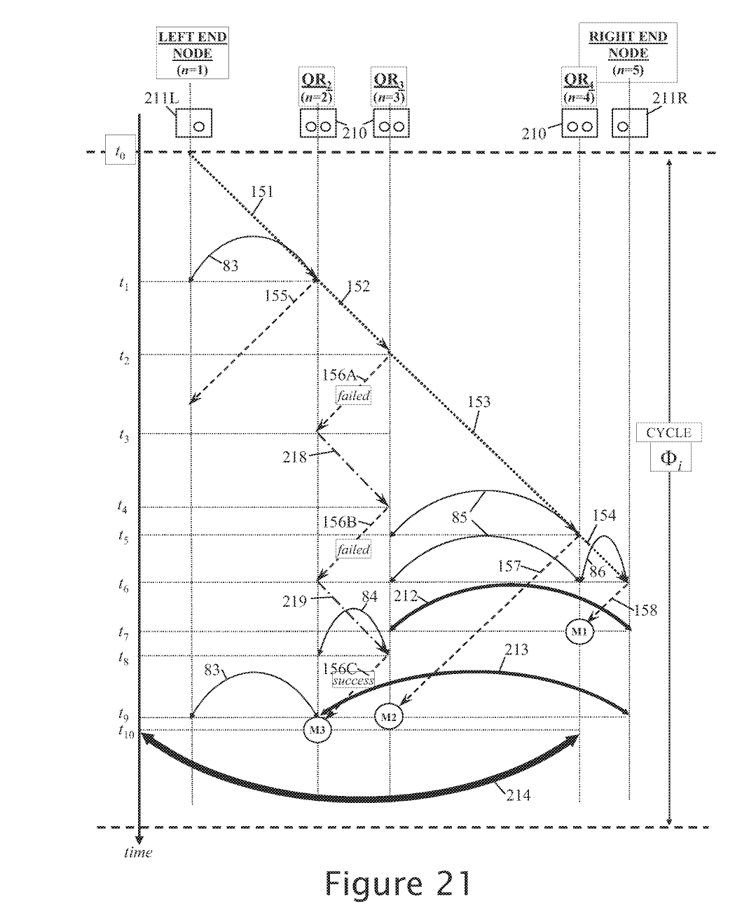

Modifications can also be made with a view to increasing the rate of successful E2E entanglement creation. Several such modifications are identified below (it being understood that these modifications can be used alone or in combination to increase the rate of E2E entanglement creation):
Enhancing LLE creation success rate. An example modification of this nature is described below with reference to FIG. 19.
Free-Running LLE Creation. This is described below after the description of the FIG. 19 modification as the latter is usefully employed in providing free-running LLE creation.
Parallel operation of node chain segments. An example modification of this nature is described below with reference to FIG. 20.

### Enhancing LLE Creation Success Rate (FIG. 19)

FIG. 19 shows a modified form of the FIG. 9 LLE creation subsystem 90 in which more than one target Q-block 94 is provided. More particularly, in the FIG. 19 LLE creation subsystem 190 the basic arrangement of the quantum physical hardware (firing squad 97 and optical merge unit 96) in node 91 is the same as for the FIG. 9 subsystem; the LLE control unit 191 of the FIG. 19 subsystem does, however, differ in certain respects from the control unit 910 of FIG. 9 as will be explained below. The main difference between the FIG. 9 and FIG. 19 subsystems, is to be found in node 92 where the quantum physical hardware now comprises multiple (p in total) target Q-blocks 94 with respective IDs 1 to p, and an optical switch 193 for directing light fields received over the local link 95 to a selected one of the target Q-blocks 94. The optical switch 193 is controlled by LLE control unit 192 of node 92 such that the incoming light fields are directed by the optical switch 193 to the same target Q-block 94 until a successful entanglement is created whereupon the optical switch 193 is switched to pass the incoming light fields to a new, available (un-entangled), target Q-block 94. The optical switch thus effectively performs the role of shuttering an entangled target qubit from subsequent light fields and thereby preventing interaction of these light fields with that qubit. Each successful entanglement is reported to the node 91 in a ‘success’ message 930 which may now also include (in addition to information permitting identification of the involved fusilier Q-block 93 and possibly parity information) the ID of the target Q-block 94 concerned.

Of course, the control unit 192 must keep track of the availability status of each of the target Q-blocks 94 since the control unit 192 is tasked with ensuring that the optical switch 193 only passes the incoming light fields to a target Q-block with an un-entangled qubit. This availability status can be readily tracked by the control unit 192 using a status register 196 arranged to store a respective entry for each target Q-block 94. Each register entry not only records the availability of the corresponding target Q-block but is also used to record, in the case where the Q-block is unavailable (because its qubit is entangled with the qubit of a fusilier Q-block), related parity information unless this is passed back to node 91 instead.

Operating node 92 in this way ensures an efficient use of the light fields fired by the firing squad 97 as they are all used to attempt entanglement creation.

The control unit 191 of node 91 also includes a status register 195, this register being arranged to store a respective entry for each fusilier Q-block 93. Each register entry records the availability of the corresponding fusilier Q-block 93; a fusilier Q-block is ‘unavailable’ between when its qubit is entangled with the qubit of a target Q-block 94 (as indicated by a message 930) and when the entanglement concerned is used up. (All fusilier Q-blocks 94 are, of course, effectively ‘unavailable’ for the round trip time between when the firing squad is triggered and a message is received back from node 92 since it is not known whether any particular fusilier Q-block is, or is about to become, involved in an entanglement; however, such ‘unavailability’ may be ignored since whether any particular fusilier Q-block has become entangled will be known before the next firing of the firing squad 97. Each entry of register 195 is also used to record, in the case where the corresponding Q-block 93 is unavailable because its qubit is entangled, and parity information where such information has been provided in the related message 930.

Where multiple LLEs are created by a single triggering of the firing squad 97, the one or more LLEs created over and above the one to be used in the merge operation to be effected in the same operating cycle, can be put to a number of uses. Thus, one, some or all of these excess LLEs can be kept in reserve (‘banked’) in a queue and so immediately available to become the LLE to be merged in a following operating cycle should the LLE creation subsystem 190 fail to create any LLE in that cycle. This, of course, requires the relevant Q-blocks 93, 94 to be kept unavailable for participation in LLE creation which can be readily achieved through reference to the status registers 195, 196. Also, the nodes sharing banked LLEs must use them in the same order (for example, the order in which they are reported in messages 930) otherwise a disjunction could occur in the line of merged LLEs intended to make up an E2E entanglement.

Excess LLEs can also be used in the process known as ‘purification’. Purification raises the fidelity of an entanglement by combining two entanglements, via local quantum operations and classical communication, into one higher-fidelity pair.

It should be noted that ‘banked’ LLEs have a limited lifetime even where qubit state has been transferred without delay from electron spin to nuclear spin; accordingly aback should be kept of the remaining lifetime of the qubits involved in banked. LLEs with LLEs that include an expiring qubit being discarded.

### Free-Running LLE Creation

It possible to decouple the operation of the LLE creation subsystem (whatever its form) from the repeater top-level operating cycle. Thus in one implementation, the right LLE creation subsystem is fired as frequently as possible (substantially with a period equal to the round trip time to the neighbour node participating in the LLE creation subsystem) and independently of when the cycle-trigger is received at the repeater—it will be appreciated that this requires the cycle-trigger to be formed by a signal that is distinct from the signals sent in the course of operation of the LLE creation subsystem. In this case, an entangled right-side qubit will become known to the repeater as being available for merging at a time after receipt of a cycle-trigger which is on average less than the round trip time to the right neighbour node. Furthermore, where the FIG. 19 LLE creation subsystem is employed and LLEs banked, there is a good chance that a right LLE will be available at the time the repeater receives a cycle trigger.

### Parallel Operation of Node Chain Segments (FIG. 20)

By splitting the chain of nodes into multiple segments each with its own pair of left and right end nodes, creation of extended entanglements can be effected in parallel (over respective segments); these E2E segment entanglements can then be merged to created the final E2E entanglement.

One particular example arrangement of such segmentation is depicted in FIG. 20. In this case, the ultimate end nodes between which it is desired to create an E2E entanglement are left end node 201 and right end node 202. The chain of nodes (end nodes 201, 202 and intermediate repeater nodes) is divided into a first segment 203 and a second segment 204.

The end nodes of the first segment 203 are the left end node 201 and a sub-node 205 of a segment-spanning node 209, this sub-node 205 serving as aright end node for the first segment. The end nodes of the second segment 204 are right end node 202 and a sub-node 206 of the segment-spanning node 209, this sub-node 206 serving as a left end node for the second segment.

The firing squads of the first segment 203 fire their light-field trains in d reaction 207, that is, away from the segment-spanning node 209; similarly, the firing squads of the second segment 204 fire their light-field trains away from the segment-spanning node 209 in direction 208. The segment-spanning node 209 is responsible for initiating propagation of cycle-trigger signals along the first and second segments 203, 204 in directions 207, 208 respectively.

The first and second segments 203, 204 create E2E segment entanglements in parallel time-wise in coordinated segment operating cycles. At the end of each coordinated pairing of segment operating cycles, E2E segment entanglements will exist across both segments. The segment-spanning node 209 now merges these E2E segment entanglements to generate the desired E2E entanglement between nodes 201 and 202. The segment-spanning node 209 thus not only possesses end node functionality but also merge functionality.

### Second “Quasi Asynchronous” Quantum Repeater Embodiment (FIG. 21)

The second “Quasi Asynchronous” quantum repeater embodiment is not separately illustrated but is similar in form to the FIG. 10 embodiment; the main difference is that the repeater LLE creation components only serve (in conjunction with complimentary components in neighbouring nodes) to provide ‘non-reliable’ LLE creation subsystems rather than the ‘reliable’ LLE creation subsystems provided by the unmodified FIG. 10 embodiment. A simple example of a (usually) non-reliable LLE creation subsystem is the subsystem 52 or 54 of FIG. 5. Due to the unreliable nature of the LLE subsystems associated with the second quantum repeater embodiment, the repeater MC unit is arranged to determine the existence of LLEs based on measurement rather than on an assumption of success. Furthermore, the R-LLE control unit (assuming light fields are fired left-to-right) is arranged, once triggered by the MC unit 77 following receipt by the latter of a cycle trigger, to repeatedly pass around a cycle of firing and awaiting receipt back of a success/failure message from the right neighbour node, until a success message is received; upon receipt of a success message, the R-LLE control unit informs the MC unit 77 to trigger transition from state 142 (FIG. 14) to state 141 (the arc 145 is omitted from the state transition diagram for the state machine 105 of the second embodiment). As a consequence, the MC unit 77 may have to wait a significant time before it can carry out a merge operation (and care must therefore be taken to monitor the remaining life of the L-side qubit in particular). The overall E2E operating cycle time is therefore variable and the left end node is arranged to initiate a new E2E cycle only when it knows that the preceding one has terminated.

FIG. 21 provides an example illustration of one E2E cycle operation for a chain of five nodes comprising left and right end nodes 211L and 211R, and three repeaters 210 of the form of the second embodiment. In this chain, the nodes are spaced by the same amounts as the nodes of the chain of nodes illustrated in FIG. 15. In fact, FIG. 21 corresponds closely to FIG. 15 but now with three attempts being needed to create an LLE between repeater nodes QR₂ and QR₃ (for simplicity it is assumed all other LLEs are created at the first attempt). The same references are used in FIG. 21 as in FIG. 15 for the LLEs (references 83 to 86), the cycle-trigger heralds (references 151 to 154) and the LLE creation result messages fed back to the firing end of the LLE creation subsystems (references 155 to 158—though as three attempts are now needed to create LLE 84, repeater node QR3 ends up sending back three such messages, referenced 156A, 156B and 156C, the first two indicating failure and the third one indicating success). The non-LLE entanglements are newly referenced in FIG. 21, references 212 and 213 indicating extended entanglements and reference 214 the final E2E entanglement. To avoid unnecessary clutter, entanglements are only depicted in FIG. 21 at the time of their creation and again just prior to being merged.

The cycle-relative times (t₀ to t₁₀) given in FIG. 21 are specific to this Figure and do not relate back to FIG. 15, this being done to allow ordered suffixing of the times. Similarly the merge numberings M1 to M3 apply specifically to FIG. 21 to reflect the time order in which merges are effected (the order in which the repeaters QR₁ to QR₃ effect their merges differs between FIGS. 15 and 21).

As already noted, the basic difference between the E2E operating cycles shown in FIGS. 15 and 21, is that in the FIG. 21 E2E operating cycle, three attempts are needed to create the LLE 84 between repeater nodes QR₂ and QR₃ as follows:
First attempt: This attempt involves the light field(s) fired by QR₂ at time t₁ as a result of receiving the cycle-trigger signal, the progress of this field(s) being substantially as indicated by dotted arrow 152 (which actually represents the herald preceding this field(s)). This attempt fails and at time t₂ QR₃ returns a ‘fail’ message indicated by dashed arrow 156A.
Second attempt: This attempt involves the light field(s) tired by QR₂ at time t₃ as a result of receiving the fail message from the first attempt, the progress of this field(s) being indicated by chained-dashed arrow 218. This second attempt also fails and at time t₄ QR₃ returns the ‘fail’ message indicated by dashed arrow 156B.
Third attempt: This attempt involves the light field(s) fired by QR₂ at time t₆ as a result of receiving the fail message from the second attempt, the progress of this field(s) being indicated by chained-dashed arrow 219. This attempt succeeds in creating LLE 84 at time t₈ and QR₃ returns a ‘success’ message indicated by dashed arrow 156C. (It is noted that, by coincidence, in this illustration the cycle trigger 154 also happens to reach the right end node 211R at time t₆).

The ‘success’ message (arrow 156C) reaches QR₂ at time t₁₀ by which time QR₃ and QR₄ have already carried out their merge operations (QR₄ being first, effecting its merge, indicated by circled ‘M1’, at time t₇ to combine LLEs 85, 86 to create extended entanglement 212, and QR₃ effecting its merge, indicated by circled ‘M2’, at time t₉ to combine LLE 84 and extended entanglement 212 to create extended entanglement 213). Thus at time t₁₀ QR2 is in a position to effect its merge, indicated by circled ‘M3’ to combine LLE 83 and extended entanglement 213 to create E2E entanglement 214.

One way in which the left end node 211L can be informed that the current E2E operating cycle has now finished and a new one can be initiated, is to arrange for the right end node 211R to send an “E2E success” MC message back along the node chain towards the left end node 211L as soon as it receives the cycle trigger 154. Each repeater node QR₃, QR₂, and QR₁ delays propagation of this “E2E success” MC message until it has carried out its merge operation. In due course, the left end node 211L receives the “E2E success” MC message and initiates a new E2E operating cycle.

It will be appreciated that many other modifications are possible to the described quantum repeater embodiments.

It may be noted that in the FIG. 10 repeater embodiment, leftward entanglement is assumed upon receipt of the cycle-trigger because the LLE creation subsystem has a high probability of success); in contrast, rightward entanglement is known through measurement and the return of the fusilier indication. Thus a local merge operation is initiated, following receipt of a cycle-trigger, when leftward entangled is expected to exist and rightward entanglement is known to exist. In fact, the existence of a leftward entanglement could be based on knowledge rather than expectation as this knowledge is readily available from the L-LLE control unit; similarly, the existence of a rightward entanglement could be based on expectation rather than knowledge since the use of a high-reliability LLE creation subsystem means that the existence of a rightward entanglement can be expected after the round trip time to the right neighbour node (of course, it is still necessary to receive information from the right neighbour node enabling identification of the entangled fusilier qubit and this information effectively provides knowledge confirming the time-based expectation of the existence of a rightward entanglement). For the second repeater embodiment based on non-reliable LLE creation subsystems, local merge operations are only effected upon knowledge of the existence of leftward and rightward entanglements.

For various reasons it may be desirable to arrange for the merging of leftward and rightward entanglements that is effected by the described quantum repeater embodiments each top-level cycle, to be carried out through the intermediary of one or more local qubits (‘intermediate qubits’) rather than directly by carrying out a ‘merge operation’ of the form described above on the relevant repeater L-side and R-side qubits. For example, where one intermediate qubit is provided, the leftward and rightward entanglements can be separately extended to the intermediate qubit by respective elongate operations involving the entangled L-side/R-side qubit (as appropriate) and the intermediate qubit; thereafter, the intermediate qubit is removed from entanglement by performing an X measurement operation upon it. It will be appreciated that the details of how the local merging of a repeater's leftward and rightward entanglements is effected is not critical to the general manner of operation of a quantum repeater operating on the ‘Quasi Asynchronous’ basis.

With regard to the implementation of the LLE control units 82, 83 and the merge control unit 87, it will be appreciated that typically the described functionality will be provided by a program controlled processor or corresponding dedicated hardware. Furthermore, the functionality of the LLE control units and the merge control unit may in practice be integrated, particularly in cases where the LLE control unit functionality is minimal. Of course, the division of control functionality is to a degree arbitrary; however, LLE control functionality merits separation into the LLE control units because in certain repeater embodiments LLE creation is free-running, that is, uncoordinated with higher level operations such as merge control. Overlying the LLE control functionality is the control functionality associated with merge control and the control of cycle-trigger propagation—this control functionality effectively provides top level control of the repeater and can be considered as being provided by a top-level control arrangement (in the described embodiments this is formed by the merge control unit, though it would also be possible for the cycle-trigger control to be separated out from the merge control unit into its own distinct control unit which, for example, is responsive to a received cycle trigger both to pass this as an event to the merge control unit and to fire the R-side firing squad, this latter action no longer being the responsibility of the merge control unit).

Although in the foregoing description light fields have generally been described as being sent over optical fibres both between nodes and between components of the quantum physical hardware of a repeater, it will be appreciated that light fields can be sent over any suitable optical channel whether guided (as with an optical waveguide) or unguided (straight line) and whether through free space or a physical medium. Thus, for example, the optical fabric of the quantum physical hardware of a repeater may comprise silicon channels interfacing with a qubit provided by a nitrogen atom in a diamond lattice located within an optical cavity.

As already indicated, persons skilled in the art will understand how the Q-blocks can be physically implemented and relevant example implementation details can be found in the following papers, herein incorporated by reference:
“Fault-tolerant quantum repeaters with minimal physical resources, and implementations based on single photon emitters” L. Childress, J. M. Taylor, A. S. Sørensen, and M. D. Lukin; Physics Review A 72, 052330 (2005).
“Fault-Tolerant Quantum Communication Based on Solid-State Photon Emitters” L. Childress, J. M. Taylor, A. S. Sørensen, and M. D. Lukin Physical Review Letters 96, 070504 (2006).
“Hybrid quantum repeater based on dispersive CQED interactions between matter qubits and bright coherent light” T D Ladd, P van Loock, K Nemoto, W J Munro, and Y Yamamoto; New Journal of Physics 8 (2006) 184, Published 8 Sep. 2006.
“Hybrid Quantum Repeater Using Bright Coherent Light” P. van Loock, T. D. Ladd, K. Sanaka, F. Yamaizuchi, Kae Nemoto, W. J. Munro, and Y. Yamamoto; Physical Review Letters 96, 240501 (2006),
“Distributed Quantum Computation Based-on Small Quantum Registers” Liang Jiang, Jacob M. Taylor, Anders S. Sørensen, Mikhail D. Lukin; Physics Review. A 76, 062323 (2007).

1. A quantum repeater optically couplable to left and right neighbour nodes through local-link optical channels; the repeater comprising:
quantum physical hardware providing left-side and right-side repeater portions (L, R) respectively arranged to support left-side and right-side qubits for entanglement with qubits in the left and right neighbour nodes respectively by light fields transmitted over the local-link channels thereby to form respective local link entanglements, herein “LLE”s; the quantum physical hardware being operable to merge two entanglements respectively involving a left-side and a right-side qubit, by locally operating on these qubits;
left and right LLE control units for controlling the quantum physical hardware to effect creation of left and right LLEs in cooperation with the left and right neighbour nodes; and
a top-level control arrangement operative in response to receipt by the repeater of a trigger from the left neighbour node, to enable initiation of a merging of entanglements respectively involving a left-side and a right-side qubit when these qubits are at least expected to be entangled leftwards and rightwards respectively, the top-level control arrangement being further operative to pass on the trigger to the right neighbour node without waiting for the merging of entanglements to be effected.

2. A quantum repeater according to claim 1, wherein the quantum physical hardware provides for at least one of: multiple left-side qubits and multiple right-side qubits; the top-level control arrangement being arranged to initiate said merging of entanglements in respect of a left-side and a right-side qubit known or expected to be entangled.

3. A quantum repeater according to claim 1, wherein the left-side repeater portion (L) and the right-side repeater portion (R) are complimentary in form; one of these repeater portions (L, R) being operative to generate a light field, pass it through its qubit, and then send the light field out over a local link channel; and the other repeater portion (R, L) being operative to receive a light field over a local link channel, pass it through its qubit and then measure the light field.

4. A quantum repeater according to claim 1, wherein:
one of the left-side and right-side repeater portions (L, R) comprises a plurality of fusilier Q-blocks each arranged to support a fusilier qubit and to pass a light field through that qubit, and an optical fabric for orderly coupling light fields that have passed through fusilier qubits, onto the corresponding local link channel; a corresponding of the LLE control units being arranged to control this repeater portion to cause the coordinated passing of respective light fields through the fusilier qubits whereby to produce an outgoing train of closely-spaced light fields on the local link channel; and
the other of the left-side and right-side repeater portions (R, L) comprises a target Q-block arranged to support a target qubit and to measure a light field passed through that qubit whereby to determine whether the target qubit has been successfully entangled, and an optical fabric for coupling the corresponding local link channel with the target Q-block to enable light fields of an incoming train of light fields received over the local link channel from a neighbour node to pass through the target qubit and be measured; a corresponding one of the LLE control units being arranged to control this repeater portion to allow a first light field of the train to pass through and potentially interact with the target qubit and thereafter only to allow a next light field through and potentially interact with the target qubit upon the target Q-block indicating that the preceding light field was unsuccessful in entangling the target qubit, this LLE control unit being responsive to the target Q-block indicating that the target qubit has been successfully entangled to pass, to the neighbour node originating the train, information identifying the light field of the train which successfully entangled the target qubit whereby to permit identification of the fusilier qubit entangled with the target qubit.

5. A quantum repeater according to claim 4, wherein the number f of fusilier Q-blocks is such as to satisfy the inequality:
P_{success}≦1−(1−s)^{f}
where:
s is the probability of successfully creating an entanglement with a single light field for a predetermined operating environment; and
P_{success} is a desired probability of successfully entangling the target qubit with a single light-field train, P_{success} being selected to be at least 99%.

6. A quantum repeater according to claim 4, wherein the incoming light train is preceded by a herald signal that serves as said trigger, the said other repeater portion (R, L) being arranged to receive the herald and communicate its receipt to the top-level control arrangement.

7. A quantum repeater according to claim 4, wherein the incoming light train is preceded by a herald signal modulated with cumulative parity information, the repeater being arranged to extract this cumulative parity information, combine it with local parity information to form new cumulative parity information, and to modulate this new cumulative parity information onto a herald signal preceding said outgoing light train.

8. A quantum repeater according to claim 6, wherein receipt of the herald signal is taken by the top-level control arrangement as indicating that an LLE exists, or will shortly do so, between the repeater and the node sending the herald; the top-level control arrangement determining that an LLE exists with the repeater's other neighbour node on receiving therefrom said information identifying the repeater fusilier qubit entangled with a target qubit in said other neighbour node.

9. A quantum repeater according to claim 4, wherein following receipt of a said trigger, the top-level control arrangement is arranged to cause the LLE control unit associated with the repeater portion (R) including the fusilier Q blocks to initiate the generation of a said outgoing train of light fields.

10. A quantum repeater according to claim 1, wherein the top-level control arrangement is arranged to store parity information based on:
merge parity information in respect of a said merging of entanglements; and
parity information in respect of an LLE involving a said qubit subject of the merging of entanglements;
the top-level control arrangement being further arranged to receive cumulative parity information from one neighbour node, to combine its stored parity information with the received cumulative parity information to form updated cumulative parity information, and to send on the updated cumulative parity information to its other neighbour node.

11. A system, comprising a chain of nodes, for creating an end-to-end entanglement between working qubits in left and right opposite end nodes of the chain, intermediate nodes of the chain being formed by quantum repeaters with each quantum repeater being linked to its neighbour nodes by local link optical channels; one end node being arranged to initiate an end-to-end operating cycle (Φ), for creating an end-to-end entanglement, by sending its neighbouring intermediate node of the chain a said trigger, the intermediate nodes serving to propagate this trigger along the chain to all nodes.

12. A system according to claim 11, wherein each end node includes an output buffer arranged to provide a qubit into which the end of an end-to-end entanglement that is anchored in a working qubit of the end node, can be transferred in order to free up that working qubit.

13. A method of creating an end-to-end entanglement between qubits in opposite end nodes of a chain of nodes coupled by optical channels, the intermediate nodes of the chain being quantum repeaters, the method comprising, in uncoordinated or coordinated relation:
creating local link entanglements, herein “LLE”s, between qubits in each pair of neighbour nodes in said chain, the LLEs being created through interaction of the qubits with light fields transmitted between the nodes; and
propagating a trigger along the chain from one end node to sequentially enable each quantum repeater to effect a top-level cycle of operation that involves initiating a merging of two entanglements each involving a respective qubit of the repeater when these qubits are at least expected to be entangled with qubits in nodes disposed in opposite directions along the chain from the repeater, each repeater passing on the trigger without waiting until it has carried out the merging of entanglements.

14. A method according to claim 13, wherein each repeater on receiving the trigger, initiates LLE creation with its neighbour node in the direction along the chain away from said one end node.

15. A method according to claim 14, wherein LLEs are created between each pair of neighbour nodes, by:
passing respective light fields through a plurality of fusilier qubits in one node of each pair and into the optical channel between the node pair, the generation and organization of the light fields being such as to result in a train of closely-spaced light fields being transmitted along the optical channel;
receiving, at the second node of each pair, light fields of said train over the optical channel between the node pair and while a target qubit remains un-entangled, allowing each light field to pass in turn through, and potentially interact with, the target qubit, each light field thereafter being measured to determine whether the target qubit has been entangled,
upon successful entanglement of the target qubit, inhibiting interaction of further light fields of the train with the target qubit and identifying which light field successfully entangled the target qubit whereby to permit identification of the fusilier qubit entangled with the target qubit.

16. A method according to claim 15, wherein said trigger takes the form of a herald signal that precedes the light train transmitted by said one node of each pair.

17. A method according to claim 16, wherein each herald signal is modulated with cumulative parity information, and further wherein the second node of each pair extracts this cumulative parity information, combines it with local parity information to form new cumulative parity information, and modulates this new cumulative parity information onto the herald signal it sends out.

18. A method according to claim 16, wherein, where the second node of a said pair of neighbour nodes is a quantum repeater, receipt of the herald signal by the latter is taken as indicating that an LLE exists, or will shortly do so, between the node pair; the repeater determining that an LLE exists with its other neighbour node on receiving therefrom identification of the repeater fusilier qubit entangled with a target qubit in said other neighbour node.

19. A method according to claim 15, wherein said one end node sends out triggers at regular intervals to cause the on-going creation of end-to-end entanglements in respective end-to-end operating cycles (Φ).

20. A method according to claim 19, wherein the end-to-end operating cycles (Φ) overlap in time without causing the top-level operating cycles of any one repeater to overlap with each other.
